(19) United States
(12) Patent Application Publication
(10) Pub. No.: US 2025/0180093 A1
(43) Pub. Date: Jun. 5, 2025

(54) SHOCK ABSORBER

(71) Applicant: Hitachi Astemo, Ltd., Ibaraki (JP)

(72) Inventor: Takamasa KOTANI, Hitachinaka-shi (JP)

(21) Appl. No.: 18/845,045

(22) PCT Filed: Mar. 7, 2023
(86) PCT No.: PCT/JP2023/008537

§ 371 Date: Sep. 9, 2024

(30) Foreign Application Priority Data
Apr. 14, 2022 (JP) 2022-067008

(51) Int. Cl. F16F 9/516; B60G 13/08; B60G 17/08; F16F 9/18; F16F 9/348

(52) U.S. Cl. CPC F16F 9/516; F16F 9/185; F16F 9/3484; B60G 13/08; B60G 17/08; B60G 2202/24; B60G 2204/62; B60G 2206/41; B60G 2500/104; B60G 2500/11; B60G 2600/21; B60G 2800/162; B60G 2800/916; F16F 2222/12; F16F 2228/04; F16F 2228/066

(57) ABSTRACT

A shock absorber includes a cylinder, a piston, a piston rod, a first passage, a first damping force generating mechanism, a second passage, and a second damping force generating mechanism. The first damping force generating mechanism includes a first valve which is fixed from both axial sides on the radially inner side and is disposed to be able to close the first passage and one or more second valves of which a fixed portion on the radially inner side is fixed from both axial ends together with the first valve and which generate a force of biasing the first passage in a valve closing direction. The second valve is formed to have a larger diameter than the inner diameter of a seat portion provided on the outer peripheral side of the first passage and at least one second valve includes a flexible promotion portion.

### TECHNICAL FIELD

The present invention relates to a shock absorber.

Priority is claimed on Japanese Patent Application No. 2022-067008, filed Apr. 14, 2022, the content of which is incorporated herein by reference.

### BACKGROUND ART

Among shock absorbers, there is one equipped with a pressure-controlled valve that applies a back pressure to the valve in a closing direction (see, for example, Patent Document 1).

### CITATION LIST

### Patent Document

Patent Document 1: Japanese Unexamined Patent Application, First Publication No. 2020-2976

### SUMMARY OF INVENTION

### Technical Problem

It is desired to improve the durability of the valves in the shock absorbers.

Thus, an object of the present invention is to provide a shock absorber capable of improving durability of a valve.

### Solution to Problem

In order to attain the above object, an aspect according to the present invention adopts a configuration of a shock absorber including: a cylinder in which a working fluid is sealed; a piston which is slidably fitted into the cylinder and divides an inside of the cylinder into two cylinder chambers; a piston rod of which a first end portion is connected to the piston and a second end portion is extended to an outside of the cylinder; a first passage through which the working fluid flows from at least one cylinder chamber as the piston moves; a first damping force generating mechanism which is provided in the first passage and generates a damping force; a second passage which is provided in parallel to the first passage and through which the working fluid flows from at least one cylinder chamber in accordance with the movement of the piston to pressurize the first damping force generating mechanism in a valve closing direction; and a second damping force generating mechanism which is provided in parallel to the second passage, wherein the first damping force generating mechanism includes a first valve which is fixed from both axial sides on the radially inner side and is disposed to be able to close the first passage and one or more second valves of which a fixed portion on the radially inner side is fixed from both axial ends together with the first valve and which generate a force of biasing the first passage in a valve closing direction, and wherein the second valve is formed to have a larger diameter than the inner diameter of a seat portion provided on the outer peripheral side of the first passage and at least one second valve includes a flexible promotion portion provided in a part on the radially outer side of the fixed portion to promote axial bending on the radially outer side in relation to the radially inner side.

### Advantageous Effects of Invention

According to the above aspect of the present invention, the durability of the valve can be improved.

### BRIEF DESCRIPTION OF DRAWINGS

FIG. 1 is a cross-sectional view showing a shock absorber according to a first embodiment of the present invention.

FIG. 2 is a cross-sectional view showing a piston, a first damping force generating mechanism, a second damping force generating mechanism, a frequency varying mechanism, and the like of the shock absorber of the first embodiment.

FIG. 3 is a half cross-sectional view showing the first damping force generating mechanism, the second damping force generating mechanism, and the like of the shock absorber of the first embodiment.

FIG. 4 is a half cross-sectional view showing a frequency sensitive mechanism and the like of the shock absorber of the first embodiment.

FIG. 5 is a plan view showing a valve disk of the shock absorber of the first embodiment.

FIG. 6 is a plan view showing a valve disk of a shock absorber according to a second embodiment of the present invention.

FIG. 7 is a plan view showing a valve disk of a shock absorber according to a third embodiment of the present invention.

### DESCRIPTION OF EMBODIMENTS

### First Embodiment

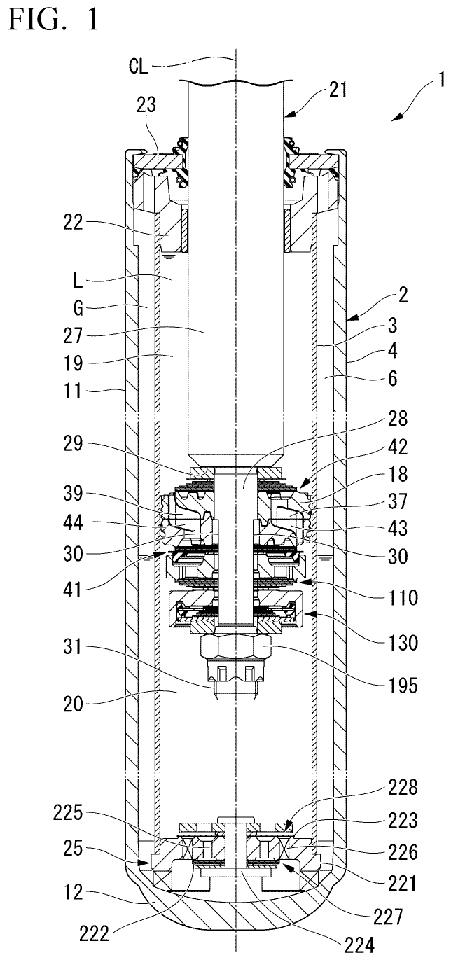

A shock absorber of a first embodiment will be described below with reference to FIGS. 1 to 5. Furthermore, in the following description, for convenience of explanation, the upper side in FIGS. 1 to 5 will be referred to as “upper”, and the lower side in FIGS. 1 to 5 will be referred to as “lower”.

As shown in FIG. 1, a shock absorber 1 of the first embodiment is a double-cylinder hydraulic shock absorber. The shock absorber 1 is used in a vehicle, specifically, in a suspension system of an automobile. The shock absorber 1 includes a cylinder 2 in which an oil Lis sealed as a working fluid. The cylinder 2 includes an inner cylinder 3 and an outer cylinder 4. The inner cylinder 3 has a cylindrical shape. The outer cylinder 4 has a bottomed cylindrical shape. The inner diameter of the outer cylinder 4 is larger than the outer diameter of the inner cylinder 3. The inner cylinder 3 is disposed on the radially inner side of the outer cylinder 4. The central axis of the inner cylinder 3 matches the central axis of the outer cylinder 4. A reservoir chamber 6 is formed between the inner cylinder 3 and the outer cylinder 4.

The outer cylinder 4 includes a body portion 11 and a bottom portion 12. The body portion 11 and the bottom portion 12 are formed seamlessly as one piece. The body portion 11 has a cylindrical shape. The bottom portion 12 closes the lower portion of the body portion 11. A mounting eye (not shown) is fixed to the bottom portion 12 on the outer side opposite the body portion 11 in the axial direction.

The shock absorber 1 includes a piston 18. The piston 18 is inserted into the inner cylinder 3 of the cylinder 2. The piston 18 is slidably fitted in the inner cylinder 3 of the cylinder 2. The piston 18 divides the inside of the inner cylinder 3 into two chambers as a cylinder chamber 19 on one side and a cylinder chamber 20 on the other side. The cylinder chamber 19 is located on the opposite side to the bottom portion 12 in relation to the piston 18 in the axial direction of the cylinder 2. The cylinder chamber 20 is located on the side of the bottom portion 12 in relation to the piston 18 in the axial direction of the cylinder 2. The oil L as a working fluid is sealed in the cylinder chamber 19 and the cylinder chamber 20 inside the inner cylinder 3. The oil L and gas G are sealed in the reservoir chamber 6 between the inner cylinder 3 and the outer cylinder 4 as a working fluid.

The shock absorber 1 includes a piston rod 21. In the piston rod 21, a first end portion on one end side in the axial direction thereof is disposed inside the inner cylinder 3 of the cylinder 2. The first end portion of the piston rod 21 is fastened to the piston 18. In the piston rod 21, a second end portion on the opposite side to the first end portion in the axial direction thereof extends from the cylinder 2 toward the outside of the cylinder 2.

The piston 18 is fixed to the piston rod 21. Therefore, the piston 18 and the piston rod 21 move together. In the shock absorber 1, a stroke in which the piston rod 21 moves in a direction to increase the amount of protrusion from the cylinder 2 is an extension stroke in which the entire length increases. In the shock absorber 1, a stroke in which the piston rod 21 moves in a direction to decrease the amount of protrusion from the cylinder 2 is a compression stroke in which the entire length decreases. In the shock absorber 1, the piston 18 moves toward the cylinder chamber 19 during the extension stroke. In the shock absorber 1, the piston 18 moves toward the cylinder chamber 20 during the compression stroke.

A rod guide 22 is fitted to the upper end opening side of the inner cylinder 3 and the upper end opening side of the outer cylinder 4. A seal member 23 is fitted to the outer cylinder 4 above the rod guide 22. Both the rod guide 22 and the seal member 23 have an annular shape. The piston rod 21 is inserted through the radially inner side of each of the rod guide 22 and the seal member 23. The piston rod 21 slides on each of the rod guide 22 and the seal member 23 along the axial direction thereof. The piston rod 21 extends from the inside of the cylinder 2 toward the outer side of the cylinder 2 in relation to the seal member 23.

The rod guide 22 restricts the piston rod 21 from moving in the radial direction relative to the inner cylinder 3 and the outer cylinder 4 of the cylinder 2. The piston rod 21 is fitted to the rod guide 22 and the piston 18 is fitted into the inner cylinder 3. Accordingly, the central axis of the piston rod 21 matches the central axis of the cylinder 2. The rod guide 22 supports the piston rod 21 to be movable in the axial direction of the piston rod 21. The outer peripheral portion of the seal member 23 is in close contact with the outer cylinder 4. The inner peripheral portion of the seal member 23 is in close contact with the outer peripheral portion of the piston rod 21. The piston rod 21 moves in the axial direction of the seal member 23 relative to the seal member 23. The seal member 23 suppresses the oil L inside the inner cylinder 3 and the high-pressure gas G and oil L inside the reservoir chamber 6 from leaking to the outside.

The outer peripheral portion of the rod guide 22 is formed so that the upper portion has a larger diameter than the lower portion. The rod guide 22 is fitted to the inner peripheral portion of the upper end of the inner cylinder 3 at the lower portion having a small diameter. The rod guide 22 is fitted to the inner peripheral portion of the upper portion of the outer cylinder 4 at the upper portion having a large diameter. A base valve 25 is installed on the bottom portion 12 of the outer cylinder 4. The base valve 25 is positioned in the radial direction relative to the outer cylinder 4. The inner peripheral portion of the lower end of the inner cylinder 3 is fitted to the base valve 25.

The upper end portion of the outer cylinder 4 is clamped inward in the radial direction of the outer cylinder 4. The seal member 23 is fixed to the cylinder 2 by being sandwiched between this clamped portion and the rod guide 22.

The piston rod 21 includes a main shaft portion 27 and a mounting shaft portion 28. Both the main shaft portion 27 and the mounting shaft portion 28 have a rod shape.

The outer diameter of the mounting shaft portion 28 is smaller than the outer diameter of the main shaft portion 27. The mounting shaft portion 28 is disposed inside the cylinder 2. The piston 18 is mounted on the mounting shaft portion 28. The main shaft portion 27 includes a shaft step portion 29. The shaft step portion 29 is provided at the end portion on the side of the mounting shaft portion 28 in the axial direction of the main shaft portion 27. The shaft step portion 29 spreads in a direction orthogonal to the central axis of the piston rod 21.

In the piston rod 21, a groove portion 30 is formed at the outer peripheral portion of the mounting shaft portion 28. The groove portion 30 extends in the axial direction of the mounting shaft portion 28. The groove portion 30 is formed by notching the outer peripheral portion of the mounting shaft portion 28 in a plane parallel to the central axis of the mounting shaft portion 28. The groove portion 30 is formed at two positions with a gap therebetween in the circumferential direction of the mounting shaft portion 28. In the mounting shaft portion 28, a threaded portion 31 is formed at the outer peripheral portion of the end portion on the opposite side to the main shaft portion 27 in relation to the groove portion 30 in the axial direction of the mounting shaft portion 28.

For example, the shock absorber 1 is connected to the vehicle body of the vehicle such that a portion protruding from the cylinder 2 of the piston rod 21 is disposed at the upper portion. At that time, the shock absorber 1 is connected to the wheel side of the vehicle such that a mounting eye (not shown) provided on the side of the cylinder 2 is disposed at the lower portion. Conversely, the shock absorber 1 may be connected to the vehicle body on the side of the cylinder 2. In this case, in the shock absorber 1, the piston rod 21 is connected to the wheel side.

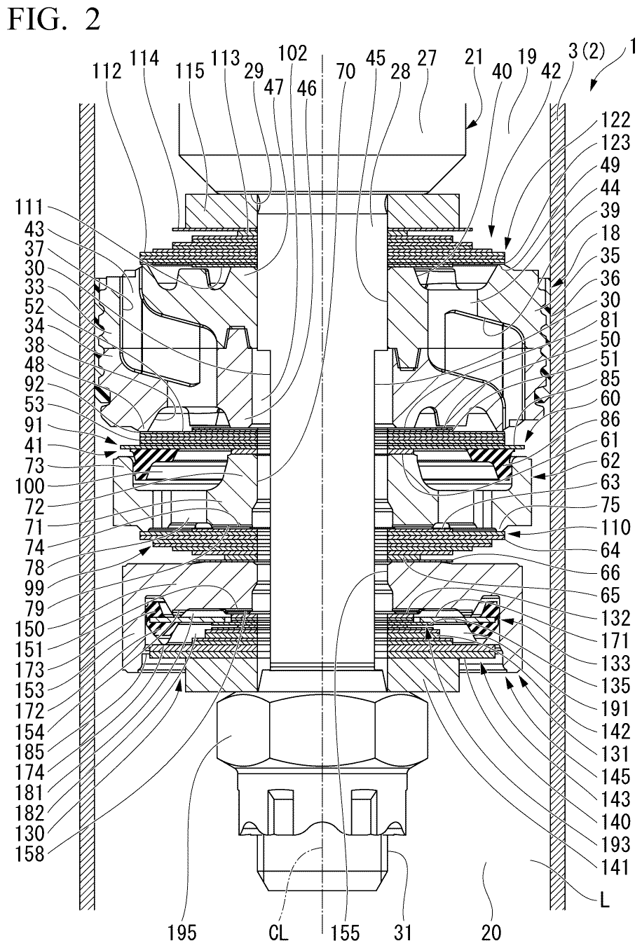

As shown in FIG. 2, the piston 18 includes a piston body 35 and a sliding member 36. The piston body 35 is formed by combining a divided body 33 and a divided body 34. The divided bodies 33 and 34 are both made of metal and have an annular shape. The divided bodies 33 and 34 are formed such that the inner diameter of the divided body 33 is smaller than the inner diameter of the divided body 34. The sliding member 36 is made of synthetic resin and has a circular band shape. The sliding member 36 is integrally mounted on the outer peripheral surface of the piston body 35 while the divided body 33 and the divided body 34 are combined. Accordingly, the divided bodies 33 and 34 and the sliding member 36 are integrated into the piston 18. In the piston 18, the divided body 33 is fitted to the mounting shaft portion 28 of the piston rod 21. The piston 18 slides on the inner cylinder 3 while the sliding member 36 is in contact with the inner cylinder 3.

The piston body 35 is provided with a passage hole 37, a passage groove 38, a passage hole 39, and a passage groove 40. The passage hole 37 extends in the axial direction of the piston body 35. The passage hole 37 is formed at a plurality of positions of the piston body 35 with a gap therebetween in the circumferential direction of the piston body 35 (only one is shown in FIG. 2 because it is a cross-sectional view). The passage hole 39 extends in the axial direction of the piston body 35. The passage hole 39 is formed at a plurality of positions of the piston body 35 with a gap therebetween in the circumferential direction of the piston body 35 (only one is shown in FIG. 2 because it is a cross-sectional view). In the piston body 35, one passage holes 37 and one passage holes 39 are formed alternately at equal intervals in the circumferential direction of the piston body 35.

The passage groove 38 is formed in the divided body 34 of the piston body 35 in a circular shape in the circumferential direction of the divided body 34. The passage groove 38 is formed at the end portion on the opposite side to the divided body 33 in the axial direction of the divided body 34. All passage holes 37 are open to the passage grooves 38 at their axial end sides in the piston body 35. The passage groove 40 is formed in the divided body 33 of the piston body 35 in a circular shape in the circumferential direction of the divided body 33. The passage groove 40 is formed at the end portion on the opposite side to the divided body 34 in the axial direction of the divided body 33. All passage holes 39 are open to the passage grooves 40 at the end portions on the opposite side to the passage groove 38 in the axial direction of the piston body 35. In the piston 18, the inside of the plurality of passage holes 37 and the inside of the passage grooves 38 form a first passage 43. The first passage 43 penetrates the piston 18 in the axial direction of the piston 18. In the piston 18, the inside of the plurality of passage holes 39 and the inside of the passage grooves 40 form a first passage 44. The first passage 44 penetrates the piston 18 in the axial direction of the piston 18. All the first passage 43 and the first passage 44 are provided in the piston 18.

The first passage 43 is provided with a first damping force generating mechanism 41. The first damping force generating mechanism 41 opens and closes the first passage 43 to generate a damping force. The first damping force generating mechanism 41 is disposed on the side of the cylinder chamber 20 which is one end side in the axial direction of the piston 18 and is mounted on the piston rod 21. Accordingly, the first passage 43 serves as a passage through which the oil L as a working fluid moves from the cylinder chamber 19 toward the cylinder chamber 20 as the piston 18 moves toward the cylinder chamber 19. That is, the first passage 43 is a passage through which the oil L flows from the cylinder chamber 19 on the upstream side toward the cylinder chamber 20 on the downstream side as the piston 18 moves during the extension stroke in the cylinder chambers 19 and 20. The first damping force generating mechanism 41 serves as an extension side damping force generating mechanism that generates a damping force by suppressing the flow of the oil L from the first passage 43 toward the cylinder chamber 20 occurring during the extension stroke.

The first passage 44 is provided with a first damping force generating mechanism 42. The first damping force generating mechanism 42 opens and closes the first passage 44 to generate a damping force. The first damping force generating mechanism 42 is disposed on the side of the cylinder chamber 19 corresponding to the other end side in the axial direction of the piston 18 and is mounted on the piston rod 21. Accordingly, the first passage 44 serves as a passage through which the oil L moves from the cylinder chamber 20 toward the cylinder chamber 19 as the piston 18 moves toward the cylinder chamber 20. That is, the first passage 44 is a passage through which the oil L flows from the cylinder chamber 20 on the upstream side toward the cylinder chamber 19 on the downstream side as the piston 18 moves during the compression stroke in the cylinder chambers 19 and 20. The first damping force generating mechanism 42 serves as a compression side damping force generating mechanism that generates a damping force by suppressing the flow of the oil L from the first passage 44 toward the cylinder chamber 19 occurring during the compression stroke.

The piston body 35 includes an insertion hole 45 formed in the radial center thereof to penetrate the piston body 35 in the axial direction. The mounting shaft portion 28 of the piston rod 21 is inserted through the insertion hole 45. In the insertion hole 45, a portion formed in the divided body 33 on the side of the cylinder chamber 19 has a smaller diameter than a portion formed in the divided body 34 on the side of the cylinder chamber 20 in the axial direction thereof. The piston body 35 is fitted to the mounting shaft portion 28 of the piston rod 21 in the divided body 33 having a small diameter in this way.

An inner seat 46 and a valve seat portion 48 (seat portion) are formed at the end portion on the side of the cylinder chamber 20 in the axial direction of the piston body 35. Both the inner seat 46 and the valve seat portion 48 have an annular shape. The inner seat 46 is disposed inside the opening of the passage groove 38 on the side of the cylinder chamber 20 in the radial direction of the piston body 35. The valve seat portion 48 is disposed outside the opening of the passage groove 38 on the side of the cylinder chamber 20 in the radial direction of the piston body 35. The valve seat portion 48 is provided on the outer peripheral side of the first passage 43. The valve seat portion 48 constitutes a part of the first damping force generating mechanism 41.

An inner seat 47 and a valve seat portion 49 are formed at the end portion on the side of the cylinder chamber 19 in the axial direction of the piston body 35. Both the inner seat 47 and the valve seat portion 49 have an annular shape. The inner seat 47 is disposed inside the opening of the passage groove 40 on the side of the cylinder chamber 19 in the radial direction of the piston body 35. The valve seat portion 49 is disposed outside the opening of the passage groove 40 on the side of the cylinder chamber 19 in the radial direction of the piston body 35. The valve seat portion 49 is provided on the outer peripheral side of the first passage 44. The valve seat portion 49 constitutes a part of the first damping force generating mechanism 42.

In the piston body 35, the openings of all passage holes 39 on the side of the cylinder chamber 20 are arranged on the opposite side to the passage groove 38 of the valve seat portion 48 in the radial direction of the piston body 35. In the piston body 35, the openings of all passage holes 37 on the side of the cylinder chamber 19 are arranged on the opposite side to the passage groove 40 of the valve seat portion 49 in the radial direction of the piston body 35.

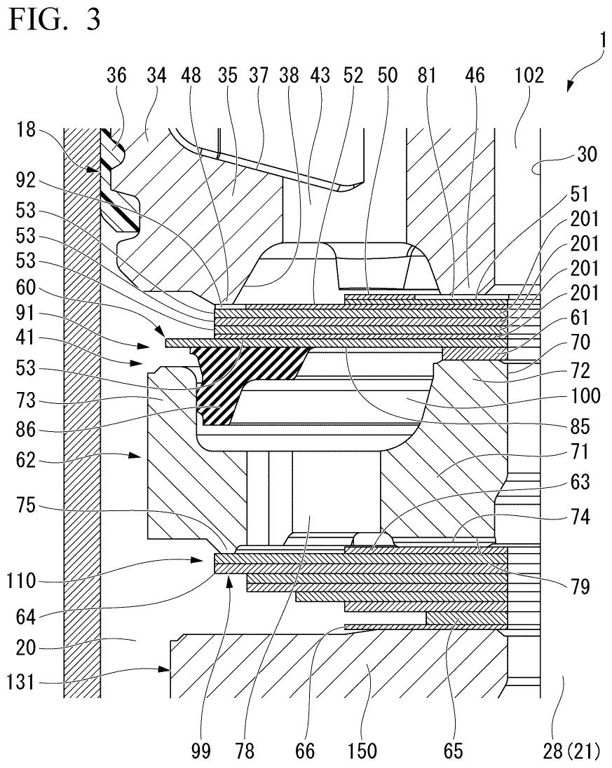

As shown in FIG. 3, one disk 50, one disk 51, one valve disk 52, a plurality of (specifically, four) valve disks 53 (second valves), one pilot valve 60 (first valve), one disk 61, one pilot case 62, one disk 63, a plurality of (specifically, six) disks 64, one disk 65, and one disk 66 are provided on the side of the inner seat 46 in the order from the piston 18 in the axial direction of the piston 18. All the disks 50, 51, 61, 63 to 66, the valve disks 52 and 53, and the pilot case 62 are made of metal. All the disks 50, 51, 61, 63 to 66 and the valve disks 52 and 53 have a circular flat plate shape with a certain thickness and hole. The mounting shaft portion 28 of the piston rod 21 is fitted into all the disks 50, 51, 61, 63 to 66 and the valve disks 52 and 53. Both the pilot valve 60 and the pilot case 62 have an annular shape. The mounting shaft portion 28 of the piston rod 21 is fitted into both the pilot valve 60 and the pilot case 62.

The pilot case 62 has a bottomed cylindrical shape. In the pilot case 62, a through hole 70 is formed at the center in the radial direction thereof. The through hole 70 penetrates the pilot case 62 in the axial direction thereof. The pilot case 62 includes a bottom portion 71, an inner cylindrical portion 72, an outer cylindrical portion 73, an inner seat portion 74, and a valve seat portion 75.

In the through hole 70, the diameter on the side of the piston 18 in the axial direction thereof is smaller than the diameter on the opposite side to the piston 18 and the mounting shaft portion 28 of the piston rod 21 is fitted to the small diameter part.

The bottom portion 71 has a circular plate shape with holes. In the bottom portion 71, a passage hole 78 which penetrates the bottom portion 71 in the axial direction of the bottom portion 71 is formed on the radially outer side of the through hole 70.

The inner cylindrical portion 72 has a cylindrical shape and protrudes from the inner peripheral edge portion of the bottom portion 71 toward the piston 18 along the axial direction of the bottom portion 71.

The outer cylindrical portion 73 has a cylindrical shape and protrudes from the outer peripheral edge portion of the bottom portion 71 toward the same side as the inner cylindrical portion 72 along the axial direction of the bottom portion 71.

The passage hole 78 is disposed between the inner cylindrical portion 72 and the outer cylindrical portion 73 in the radial direction of the bottom portion 71.

The inner seat portion 74 has an annular shape and slightly protrudes from the inner peripheral edge portion of the bottom portion 71 toward the opposite side to the inner cylindrical portion 72 in the axial direction. The inner seat portion 74 is provided with a passage groove 79 which penetrates the inner seat portion 74 in the radial direction thereof.

The valve seat portion 75 has an annular shape with a larger diameter than the inner seat portion 74. The valve seat portion 75 protrudes from the bottom portion 71 toward the same side as the inner seat portion 74 along the axial direction of the bottom portion 71 on the outside of the inner seat portion 74 in the radial direction of the inner seat portion 74.

The passage hole 78 is disposed between the inner seat portion 74 and the valve seat portion 75 in the radial direction of the bottom portion 71. The passage inside the passage groove 79 of the inner seat portion 74 constantly communicates with the passage inside the groove portion 30 of the piston rod 21 and the passage inside the passage hole 78.

The disk 50 comes into contact with the inner seat 46 of the piston 18. The outer diameter of the disk 50 is constant over the entire circumference and is smaller than the inner diameter of the valve seat portion 48. The disk 50 is provided with a notch 81 extending from the inner peripheral portion. The passage inside the notch 81 always communicates with the passage inside the passage groove 38 of the first passage 43 of the piston 18 and the passage inside the groove portion 30 of the piston rod 21.

The disk 51 comes into contact with the opposite side to the piston 18 in the axial direction of the disk 50. The disk 51 has a constant outer diameter over the entire circumference, has a constant inner diameter over the entire circumference, and a constant radial width. The outer diameter of the disk 51 is equal to the outer diameter of the disk 50.

The valve disk 52 comes into contact with the opposite side to the disk 50 in the axial direction of the disk 51. A notched fixed orifice 92 is formed on the outer peripheral side of the valve disk 52. The outer diameter of the valve disk 52 excluding the fixed orifice 92 is larger than the inner diameter of the tip surface on the protruding tip side of the valve seat portion 48 in the axial direction of the piston 18 and is equal to the outer diameter of the tip surface.

The outer peripheral side of the valve disk 52 comes into contact with the valve seat portion 48 of the piston 18. The valve disk 52 opens and closes the opening of the first passage 43 formed in the piston 18 by separating from and coming into contact with the valve seat portion 48. The fixed orifice 92 of the valve disk 52 allows communication between the inside and outside of the valve seat portion 48 in the radial direction even when the valve disk 52 comes into contact with the valve seat portion 48. The valve disk 52 is slightly elastically deformed to come into contact with the valve seat portion 48. Accordingly, the valve disk 52 generates a biasing force in a direction of coming into contact with the valve seat portion 48 due to its elasticity.

The plurality of valve disks 53 are arranged on the opposite side to the disk 51 in the axial direction of the valve disk 52. The plurality of valve disks 53 are stacked along the axial direction of the valve disk 52. In the plurality of valve disks 53, the valve disk 53 closest to the valve disk 52 in the stacking direction comes into contact with the valve disk 52.

All valve disks 53 have a constant outer diameter over the entire circumference and a constant inner diameter over the entire circumference. All valve disks 53 have a constant radial width. The plurality of valve disks 53 have the same outer diameter and the same inner diameter. All valve disks 53 have the same shape when viewed from the axial direction. Further, the thickness of each of the valve disks 53 is appropriately set. At least one of the valve disks 53 has a thickness different from the rest. Of course, it is possible for all valve disks 53 to have the same thickness or it is also possible for all valve disks 53 to have different thicknesses.

The outer diameter of each of the plurality of valve disks 53 is equal to the outer diameter of the valve disk 52 excluding the fixed orifice 92. Thus, the outer diameter of each of the plurality of valve disks 53 is larger than the inner diameter of the tip surface of the protruding tip of the valve seat portion 48. The outer diameter of each of the plurality of valve disks 53 is formed to be equal to the outer diameter of the tip surface on the protruding tip side of the valve seat portion 48.

The plurality of valve disks 53 are slightly elastically deformed to come into contact with the valve disk 52. Accordingly, the plurality of valve disks 53 generate a biasing force in a direction of coming into contact with the valve seat portion 48 due to their elasticity. As a result, the plurality of valve disks 53 apply a biasing force in a direction of coming into contact with the valve seat portion 48 to the valve disk 52 due to their elasticity. The valve disk 53 may be a plurality of disks and may be a single disk.

The pilot valve 60 includes a pilot disk 85 and a seal member 86.

The pilot disk 85 is made of metal and has a circular plate shape with holes. The pilot disk 85 has a constant outer diameter over the entire circumference and a constant inner diameter over the entire circumference. The pilot disk 85 has a constant radial width.

The mounting shaft portion 28 of the piston rod 21 is fitted to the pilot disk 85. In the plurality of valve disks 53, the valve disk 53 on the most opposite side to the piston 18 in the axial direction comes into contact with the pilot disk 85 of the pilot valve 60. The outer diameter of the pilot disk 85 is larger than the outer diameter of the valve disk 53. Thus, the outer diameter of the pilot valve 60 is larger than the outer diameter of the valve disk 53.

The pilot disk 85 is slightly elastically deformed to come into contact with the valve disk 53. Accordingly, the pilot disk 85 generates a biasing force in a direction of coming into contact with the valve seat portion 48 due to its elasticity. As a result, the pilot disk 85 applies a biasing force in a direction of coming into contact with the valve seat portion 48 to the valve disks 52 and 53 due to its elasticity.

The seal member 86 is made of rubber, and is adhered to the pilot disk 85 on the opposite side to the valve disk 53 in the axial direction. The seal member 86 is fixed to the outer peripheral side of the pilot disk 85 and has an annular shape. The seal member 86 is fitted liquid-tightly to the inner peripheral portion of the outer cylindrical portion 73 of the pilot case 62 over the entire circumference. The seal member 86 is slidable on the inner peripheral portion of the outer cylindrical portion 73 in the axial direction. The seal member 86 constantly seals a gap between the pilot valve 60 and the outer cylindrical portion 73.

In the pilot valve 60, one axial end portion is defined as a first axial end portion and the other axial end portion on the opposite side to the first axial end portion is defined as a second axial end portion. Then, the pilot valve 60 includes the seal member 86 at the first axial end portion. Further, the valve disk 53 is provided at the second axial end portion of the pilot valve 60.

The valve disk 52, the plurality of valve disks 53, and the pilot valve 60 constitute a damping valve 91. The first passage 43 is formed between the damping valve 91 and the valve seat portion 48 of the piston 18. When the damping valve 91 is opened by being separated from the valve seat portion 48 of the piston 18, the first passage 43 is opened and the oil L flows from the first passage 43 toward the cylinder chamber 20. At that time, the damping valve 91 suppresses the flow of the oil L between the valve seat portion 48 and the damping valve. The damping valve 91 constitutes the first damping force generating mechanism 41 on the extension side. The damping valve 91 is provided with the fixed orifice 92 which allows the first passage 43 to communicate with the cylinder chamber 20 even when the valve disk 52 comes into contact with the valve seat portion 48. The fixed orifice 92 constitutes the first passage 43 and constitutes the first damping force generating mechanism 41. Here, it is also possible to adopt a configuration in which the fixed orifice 92 is not provided in the first passage 43. For this reason, the first passage 43 may be a passage through which the oil L flows out of at least one of the cylinder chambers 19 and 20 as the piston 18 moves.

With the above-described configuration, in the first damping force generating mechanism 41, the pilot valve 60 is disposed to be able to close the first passage 43 through the valve disks 52 and 53. Each of the valve disk 52, the plurality of valve disks 53, and the pilot disk 85 constituting the first damping force generating mechanism 41 generates a biasing force in a direction of closing the first passage 43 due to the elasticity thereof.

The disk 61 comes into contact with the opposite side to the valve disk 53 of the pilot disk 85 of the pilot valve 60. The disk 61 comes into contact with the inner cylindrical portion 72 of the pilot case 62. The outer diameter of the disk 61 is equal to the outer diameter of the inner seat 46 of the piston 18.

The disk comes into contact with the inner seat portion 74 of the pilot case 62. The outer diameter of the disk 63 is smaller than the inner diameter of the valve seat portion 75 of the pilot case 62.

The plurality of disks 64 are arranged so that the disk 64 on the side of the disk 63 in the axial direction can be seated on the valve seat portion 75. The plurality of disks 64 constitute the disk valve 99. The disk valve 99 can be separated from and seated on the valve seat portion 75. The outer diameter of the disk valve 99 becomes smaller as it moves away from the valve seat portion 75 in the axial direction.

The outer diameter of the disk 65 is smaller than the minimum outer diameter of the disk valve 99.

The outer diameter of the disk 66 is larger than the outer diameter of the disk 65.

A back pressure chamber 100 is formed between the bottom portion 71, the inner cylindrical portion 72, and the outer cylindrical portion 73 of the pilot case 62 and the pilot valve 60 and the disk 61, between the bottom portion 71, the inner seat portion 74, and the valve seat portion 75 of the pilot case 62 and the disk 63 and the disk valve 99, and inside the passage hole 78 of the pilot case 62. The back pressure chamber 100 applies a pressure in a direction of the piston 18 to the plurality of valve disks 53 and the valve disk 52 through the pilot valve 60. In other words, the back pressure chamber 100 applies an internal pressure to the damping valve 91 in a valve closing direction so that the damping valve is seated on the valve seat portion 48. At that time, the pilot valve 60 is bent by the pressure applied from the back pressure chamber 100 so that the radially outer side of the valve seat portion 48 covers the valve disk 53. The damping valve 91 and the back pressure chamber 100 constitute a part of the first damping force generating mechanism 41. The back pressure chamber 100 constantly communicates with the passage inside the groove portion 30 of the piston rod 21 through the passage inside the passage groove 79 of the pilot case 62.

The disk valve 99 is separated from the valve seat portion 75 to communicate the back pressure chamber 100 with the cylinder chamber 20. At that time, the disk valve 99 suppresses the flow of the oil L between the valve seat portion 75 and the disk valve.

The disk valve 99 and the valve seat portion 75 constitute a second damping force generating mechanism 110. The second damping force generating mechanism 110 allows the back pressure chamber 100 to communicate with the cylinder chamber 20 when the disk valve 99 is separated from the valve seat portion 75. At that time, the second damping force generating mechanism 110 generates a damping force by suppressing the flow of the oil L between the back pressure chamber 100 and the cylinder chamber 20.

In the second damping force generating mechanism 110, the oil L flows from the cylinder chamber 19 shown in FIG. 2 to the cylinder chamber 20 through the passages inside the plurality of passage holes 37 and the passage groove 38 of the first passage 43, the passage inside the notch 81 of the disk 50, the passage inside the groove portion 30 of the piston rod 21, the passage inside the passage groove 79 of the pilot case 62, the back pressure chamber 100, and the passage between the disk valve 99 and the valve seat portion 75 during the extension stroke. The second damping force generating mechanism 110 is an extension side damping force generating mechanism which suppresses the flow of the oil L from the back pressure chamber 100 toward the cylinder chamber 20 occurring during the extension stroke and generates a damping force.

The passages inside the plurality of passage holes 37 and the passage groove 38 of the first passage 43, the passage inside the notch 81 of the disk 50, the passage inside the groove portion 30 of the piston rod 21, the passage inside the passage groove 79 of the pilot case 62, the back pressure chamber 100, and the passage between the disk valve 99 and the valve seat portion 75 constitute a second passage 102. The second damping force generating mechanism 110 is provided in the second passage 102. The second passage 102 constantly communicates with the cylinder chamber 19 through the passages inside the plurality of passage holes 37 and the passage groove 38 of the first passage 43, the passage inside the notch 81, the passage inside the groove portion 30, the passage inside the passage groove 79, and the back pressure chamber 100. The second passage 102 is a passage through which the oil L flows from the cylinder chamber 19 on the upstream side toward the cylinder chamber 20 on the downstream side as the piston 18 moves during the extension stroke in the cylinder chambers 19 and 20.

In the second passage 102, the passages inside the passage hole 37 and the passage groove 38 of the piston 18 are common to the first passage 43. In the second passage 102, the passage inside the notch 81 of the disk 50, the passage inside the groove portion 30 of the piston rod 21, the passage inside the passage groove 79 of the pilot case 62, the back pressure chamber 100, and the passage between the disk valve 99 and the valve seat portion 75 are provided in parallel to the passage between the damping valve 91 and the valve seat portion 48 in the first passage 43 so that the cylinder chamber 19 and the cylinder chamber 20 can communicate with each other. The first damping force generating mechanism 41 on the extension side controls the opening of the damping valve 91 due to the pressure of the oil L introduced into the back pressure chamber 100 of the second passage 102. The back pressure chamber 100 of the second passage 102 pressurizes the damping valve 91 of the first damping force generating mechanism 41 in a valve closing direction.

Here, in the second passage 102, a fixed orifice that allows the second passage 102 to constantly communicate with the cylinder chamber 20 can also be provided between the disk valve 99 and the valve seat portion 75. For this reason, the second passage 102 may be a passage through which the oil L flows from at least one cylinder chamber 19 of the cylinder chambers 19 and 20 as the piston 18 moves.

As shown in FIG. 2, one disk 111, a plurality of (specifically, nine) disks 112, one disk 113, one disk 114, and one annular member 115 are provided in the order from the piston 18 in the axial direction of the piston 18 on the side of the valve seat portion 49 in the axial direction of the piston 18. All the disks 111 to 114 and the annular member 115 are made of metal. All the disks 111 to 114 and the annular member 115 have a circular flat plate shape with a certain thickness and hole. The mounting shaft portion 28 of the piston rod 21 is fitted into all the disks 111 to 114 and the annular member 115.

The disk 111 comes into contact with a portion on the radially inner side of the passage groove 40 of the piston 18.

In the plurality of disks 112, the disk 112 closest to the piston 18 in the axial direction comes into contact with the valve seat portion 49 of the piston 18. The plurality of disks 112 open and close the opening of the first passage 44 formed in the piston 18 by separating from and coming into contact with the valve seat portion 49.

The plurality of disks 112 constitute the disk valve 122. The disk valve 122 can be separated from and seated on the valve seat portion 49. The first passage 44 is formed between the disk valve 122 and the valve seat portion 49 of the piston 18. When the disk valve 122 is opened by being separated from the valve seat portion 49, the first passage 44 is opened and the first passage 44 is opened to the cylinder chamber 19. When the disk valve 122 is separated from the valve seat portion 49 of the piston 18, the oil L flows from the first passage 44 toward the cylinder chamber 19. At that time, the disk valve 122 suppresses the flow of the oil L between the valve seat portion 49 and the disk valve. Thus, the disk valve 122 suppresses the flow of the oil L from the cylinder chamber 20 toward the cylinder chamber 19 through the first passage 44.

The disk valve 122 and the valve seat portion 49 constitute the first damping force generating mechanism 42 on the compression side. The disk valve 122 is provided with a fixed orifice 123 which allows the first passage 44 to communicate with the cylinder chamber 19 even when coming into contact with the valve seat portion 49. The fixed orifice 123 constitutes the first passage 44 and constitutes the first damping force generating mechanism 42. Here, it is also possible to adopt a configuration in which the fixed orifice 123 is not provided in the first passage 44. For this reason, the first passage 44 may be a passage through which the oil L flows from at least one cylinder chamber 20 of the cylinder chambers 19 and 20 as the piston 18 moves.

The outer diameter of the disk 113 is smaller than the minimum outer diameter of the disk valve 122.

The outer diameter of the disk 114 is larger than the outer diameter of the disk 113. The disk 114 and the annular member 115 come into contact with the disk valve 122 when the disk valve 122 is deformed in the opening direction, thereby suppressing the disk valve 122 from deforming in the opening direction more than a specified amount. The annular member 115 comes into contact with the shaft step portion 29 of the piston rod 21.

A frequency sensitive mechanism 130 is provided on the opposite side to the disk 65 in the axial direction of the disk 66. The frequency sensitive mechanism 130 varies the damping force according to the frequency of the axial movement of the piston 18 (hereinafter, referred to as the piston frequency).

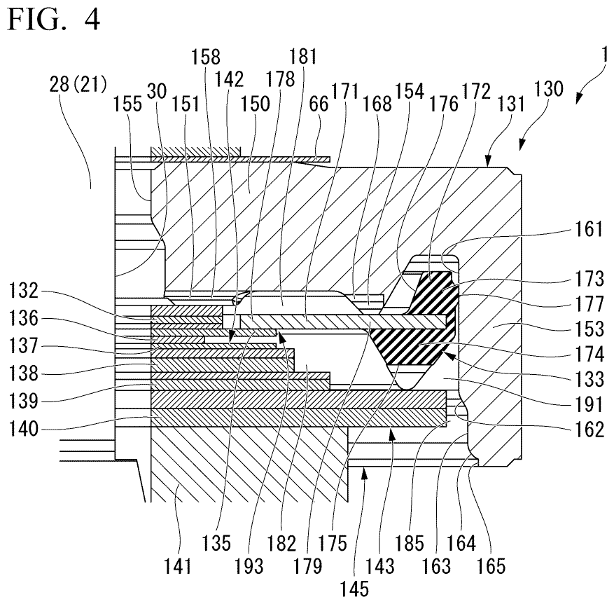

As shown in FIG. 4, the frequency sensitive mechanism 130 includes one case member 131 on the side of the disk 66 in the axial direction. The frequency sensitive mechanism 130 includes a plurality of (specifically, three) disks 132 having the same outer diameter and inner diameter and one valve member 133 on the opposite side to the disk 66 in the axial direction of the case member 131. The frequency sensitive mechanism 130 includes one flexible member 135, one disk 136, one stopper disk 137, a plurality of (specifically, two) stopper disks 138 having the same outer diameter and inner diameter, a plurality of (specifically, two) stopper disks 139 having the same outer diameter and inner diameter, and a plurality of (specifically, two) disks 140 having the same outer diameter and inner diameter in the order from the disk 132 and the valve member 133 on the opposite side to the disk 66 in the axial direction of the disk 132 and the valve member 133. An annular member 141 is provided on the opposite side to the stopper disk 139 in the axial direction of the disk 140. The stopper disk 137, the plurality of stopper disks 138, and the plurality of stopper disks 139 constitute a stopper 142. The plurality of disks 140 constitute a support member 143.

All the case member 131, the disks 132, 136, and 140, the flexible member 135, the stopper disks 137 to 139, and the annular member 141 are made of metal. All the disks 132, 136, and 140, the flexible member 135, the stopper disks 137 to 139, and the annular member 141 have a circular flat plate shape with a certain thickness and hole. In other words, all the disks 132, 136, and 140, the flexible member 135, the stopper disks 137 to 139, and the annular member 141 are formed by annular plate-shaped members. All the disks 132, 136, and 140, the valve member 133, the flexible member 135, the stopper disks 137 to 139, and the annular member 141 are arranged on the radially inner side of the case member 131. The mounting shaft portion 28 of the piston rod 21 is fitted into all the case member 131, the disks 132, 136, and 140, the flexible member 135, the stopper disks 137 to 139, and the annular member 141. Accordingly, the central axes of all the case member 131, the disks 132, 136, and 140, the flexible member 135, the stopper disks 137 to 139, and the annular member 141 match the central axis of the piston rod 21. The mounting shaft portion 28 of the piston rod 21 and the plurality of disks 132 are inserted through the inner peripheral side of the valve member 133 with radial gaps therebetween. In the frequency sensitive mechanism 130, the case member 131, the disks 132, 136, and 140, the flexible member 135, and the stopper disks 137 to 139 constitute a valve case 145. The frequency sensitive mechanism 130 includes the valve member 133 inside the valve case 145.

The case member 131 has a bottomed cylindrical shape.

A through hole 155 penetrating the case member 131 in the axial direction is formed at the center of the case member 131 in the radial direction. As shown in FIG. 2, the through hole 155 has a smaller diameter on the side of the piston 18 in the axial direction than the opposite side to the piston 18 and the mounting shaft portion 28 of the piston rod 21 is fitted to the small diameter part.

As shown in FIG. 4, the case member 131 includes a bottom portion 150, a protrusion portion 151, a cylindrical portion 153, and a seat portion 154.

The bottom portion 150 has a circular plate shape with holes. The bottom portion 150 has a constant radial width over the entire circumference. The bottom portion 150 is provided with the through hole 155.

The protrusion portion 151 has an annular shape. The protrusion portion 151 protrudes from the inner peripheral edge portion of the bottom portion 150 toward the opposite side to the disk 66 along the axial direction of the bottom portion 150. The protrusion portion 151 is provided with a passage groove 158 which penetrates the protrusion portion 151 in the radial direction. The passage inside the passage groove 158 communicates with the passage inside the groove portion 30 of the piston rod 21.

The cylindrical portion 153 has a cylindrical shape with an inner diameter larger than the outer diameter of the protrusion portion 151. The cylindrical portion 153 extends from the outer peripheral edge portion of the bottom portion 150 toward the same side as the protrusion portion 151 along the axial direction of the bottom portion 150. The cylindrical portion 153 includes a small diameter portion 161, a first inclined portion 162, a large diameter portion 163, a second inclined portion 164, and an opening end portion 165 in the order from the bottom portion 150 in the axial direction on the inner peripheral side thereof. The small diameter portion 161, the first inclined portion 162, the large diameter portion 163, the second inclined portion 164, and the opening end portion 165 have the same central axis.

The small diameter portion 161 is located on the side of the bottom portion 150 in the axial direction of the cylindrical portion 153. The small diameter portion 161 has a cylindrical inner peripheral surface.

The first inclined portion 162 extends toward the opposite side to the bottom portion 150 from the end portion on the opposite side to the bottom portion 150 in the axial direction of the small diameter portion 161. The first inclined portion 162 has an inner peripheral surface of which an inner diameter becomes larger as it moves toward the side opposite to the bottom portion 150 in the axial direction of the cylindrical portion 153. In other words, the first inclined portion 162 extends while expanding in the axial direction of the cylindrical portion 153 toward the opposite side to the bottom portion 150. The first inclined portion 162 has a tapered shape.

The large diameter portion 163 extends from the end portion on the opposite side to the bottom portion 150 in the axial direction of the first inclined portion 162 toward the opposite side to the bottom portion 150. The large diameter portion 163 has a cylindrical inner peripheral surface. The inner diameter of the large diameter portion 163 is larger than the inner diameter of the small diameter portion 161. The axial length of the large diameter portion 163 is shorter than the axial length of the small diameter portion 161. The first inclined portion 162 is provided between the small diameter portion 161 and the large diameter portion 163 in the axial direction of the cylindrical portion 153.

The second inclined portion 164 extends from the end portion on the opposite side to the bottom portion 150 in the axial direction of the large diameter portion 163 toward the opposite side to the bottom portion 150. The inner peripheral surface of the second inclined portion 164 has a larger diameter as it moves toward the opposite side to the bottom portion 150 in the axial direction of the cylindrical portion 153. In other words, the second inclined portion 164 extends while expanding in the axial direction of the cylindrical portion 153 toward the opposite side to the bottom portion 150. In other words, the second inclined portion 164 is inclined so that the inner diameter becomes smaller as it moves toward the bottom portion 150 in the axial direction of the cylindrical portion 153. The second inclined portion 164 is located on the opposite side to the bottom portion 150 of the large diameter portion 163 in the axial direction of the cylindrical portion 153. The second inclined portion 164 has a rounded chamfered shape.

The opening end portion 165 extends from the end portion on the opposite side to the bottom portion 150 in the axial direction of the second inclined portion 164 toward the opposite side to the bottom portion 150. The opening end portion 165 is located at the end portion on the opposite side to the bottom portion 150 in the axial direction of the cylindrical portion 153. The opening end portion 165 has a cylindrical inner peripheral surface. The inner diameter of the opening end portion 165 is larger than the inner diameter of the large diameter portion 163. The axial length of the opening end portion 165 is shorter than the axial length of the large diameter portion 163.

With the above-described configuration, the cylindrical portion 153 includes the small diameter portion 161 which extends from the bottom portion 150 and has a small diameter on the side of the bottom portion 150 and the large diameter portion 163 which is disposed on the opposite side to the bottom portion 150 in relation to the small diameter portion 161 and has a larger inner diameter than the small diameter portion 161. Further, the cylindrical portion 153 includes the first inclined portion 162 which is provided between the small diameter portion 161 and the large diameter portion 163 in an inclined state to connect the small diameter portion 161 and the large diameter portion 163. Further, the cylindrical portion 153 includes the second inclined portion 164 which is provided on the opposite side to the bottom portion 150 in relation to the large diameter portion 163 so that the inner diameter becomes smaller as it moves toward the bottom portion 150.

The disk 132 has a constant outer diameter over the entire circumference and a constant radial width over the entire circumference. The outer diameter of the disk 132 is slightly smaller than the outer diameter of the end surface on the opposite side to the bottom portion 150 in the axial direction of the protrusion portion 151.

The flexible member 135 has a constant outer diameter over the entire circumference and a constant radial width over the entire circumference. The outer diameter of the flexible member 135 is larger than the outer diameter of the disk 132.

The disk 136 has a constant outer diameter over the entire circumference and a constant radial width over the entire circumference. The outer diameter of the disk 136 is smaller than the outer diameter of the flexible member 135 and is smaller than the outer diameter of the disk 132.

The stopper disk 137 has a constant outer diameter over the entire circumference and a constant radial width over the entire circumference. The outer diameter of the stopper disk 137 is larger than the outer diameter of the disk 136 and is equal to the outer diameter of the flexible member 135.

The stopper disk 138 has a constant outer diameter over the entire circumference and a constant radial width over the entire circumference. The outer diameter of the stopper disk 138 is larger than the outer diameter of the stopper disk 137.

The stopper disk 139 has a constant outer diameter over the entire circumference and a constant radial width over the entire circumference. The outer diameter of the stopper disk 139 is larger than the outer diameter of the stopper disk 138.

The stopper 142 includes the stopper disks 137 to 139 as described above. In other words, the stopper 142 includes the stopper disks 137 to 139 each formed by an annular plate-shaped member. In the stopper disks 137 and 138, the outer diameter of the stopper disk 138 provided on the opposite side to the flexible member 135 is larger than the outer diameter of the stopper disk 137 provided on the side of the flexible member 135 in the axial direction of the case member 131. In the stopper disks 138 and 139, the outer diameter of the stopper disk 139 provided on the opposite side to the flexible member 135 is larger than the outer diameter of the stopper disk 138 provided on the side of the flexible member 135 in the axial direction of the case member 131.

The disk 140 constituting the support member 143 has a constant outer diameter over the entire circumference and a constant radial width over the entire circumference. The outer diameter of the disk 140 is larger than the outer diameter of the stopper disk 139.

All the disks 132, 136, and 140, the valve member 133, the flexible member 135, the stopper disks 137 to 139, and the annular member 141 are arranged on the radially inner side of the cylindrical portion 153. In other words, the outer diameters of all the disks 132, 136, and 140, the valve member 133, the flexible member 135, the stopper disks 137 to 139, and the annular member 141 are smaller than the inner diameter of the overlapping part in the axial direction of the cylindrical portion 153. All the disks 132, 136, and 140, the valve member 133, the flexible member 135, and the stopper disks 137 to 139 are arranged within the range of the cylindrical portion 153 in the axial direction of the cylindrical portion 153. A part of the annular member 141 is disposed within the range of the cylindrical portion 153 in the axial direction of the cylindrical portion 153 and the remaining part is disposed outside the range of the cylindrical portion 153 in the axial direction of the cylindrical portion 153.

The disks 132 and 136, the stopper disks 137 to 139, and the flexible member 135 are arranged within the range of the small diameter portion 161 in the axial direction of the cylindrical portion 153. The outer diameters of all the disks 132 and 136, the stopper disks 137 to 139, and the flexible member 135 are smaller than the inner diameter of the small diameter portion 161.

The support member 143 including the plurality of disks 140 is positioned to overlap the small diameter portion 161, the first inclined portion 162, and the large diameter portion 163 in the axial direction of the cylindrical portion 153. The outer diameter of the disk 140, that is, the support member 143, is smaller than the inner diameter of the small diameter portion 161. The first inclined portion 162 is provided within the range of the support member 143 over the entire length in the axial direction of the cylindrical portion 153.

The annular member 141 is positioned to overlap the large diameter portion 163, the second inclined portion 164, and the opening end portion 165 in the axial direction of the cylindrical portion 153. The outer diameter of the annular member 141 is smaller than the inner diameter of the large diameter portion 163. The second inclined portion 164 and the opening end portion 165 are provided within the range of the annular member 141 over the entire length in the axial direction of the cylindrical portion 153.

The seat portion 154 has an annular shape. The seat portion 154 protrudes from the position between the protrusion portion 151 and the cylindrical portion 153 in the radial direction of the bottom portion 150 toward the same side as the protrusion portion 151 and the cylindrical portion 153 along the axial direction of the bottom portion 150. The seat portion 154 includes a notch portion 168 formed at the protruding tip portion to penetrate the tip portion in the radial direction of the seat portion 154. The seat portion 154 is provided with the plurality of notch portions 168 formed at intervals in the circumferential direction of the seat portion 154. Thus, the seat portion 154 includes a protruding tip portion intermittently notched in the circumferential direction of the seat portion 154. The protruding height of the seat portion 154 from the bottom portion 150 is larger than the protruding height of the protrusion portion 151 from the bottom portion 150 in the axial direction of the bottom portion 150.

The valve member 133 includes a valve disk 171 and an elastic seal member 172. The valve member 133 is disposed between the cylindrical portion 153 of the case member 131 and the plurality of disks 132 in the radial direction.

The valve disk 171 is made of metal. The valve disk 171 has a circular flat plate shape with a certain thickness and hole. The valve disk 171 has a constant outer diameter over the entire circumference and a constant radial width over the entire circumference. The mounting shaft portion 28 of the piston rod 21 and the plurality of disks 132 are inserted through the inner peripheral side of the valve disk 171. The valve disk 171 is elastically deformable, that is, flexible. The valve disk 171 has an inner diameter that allows the plurality of disks 132 to be disposed inside with radial gaps. That is, the inner diameter of the valve disk 171 is larger than the outer diameters of the plurality of disks 132. The outer diameter of the valve disk 171 is smaller than the inner diameter of the small diameter portion 161 of the cylindrical portion 153. The valve disk 171 has a thickness smaller than the combined thickness of all disks 132.

The elastic seal member 172 is made of rubber and has an annular shape. The elastic seal member 172 is bonded to the outer peripheral side of the valve disk 171. The elastic seal member 172 is baked onto the valve disk 171 and is provided integrally with the valve disk 171.

The elastic seal member 172 includes a seal portion 173 and a biasing portion 174.

The seal portion 173 has an annular shape and is fixed to the outer peripheral side of the valve disk 171 over the entire circumference. The seal portion 173 protrudes from the valve disk 171 toward the bottom portion 150 of the case member 131 in the axial direction of the valve member 133.

The biasing portion 174 has an annular shape and protrudes from the valve disk 171 toward the opposite side to the bottom portion 150 in the axial direction of the valve member 133. The biasing portion 174 is fixed to the outer peripheral side of the valve disk 171. The seal portion 173 and the biasing portion 174 are connected to each other on the outer periphery of the valve disk 171 to form a single unit. In the biasing portion 174, the outer diameter becomes smaller and the inner diameter becomes larger in the axial direction thereof as it moves away from the valve disk 171. Accordingly, the cross-sectional shape of the biasing portion 174 taken along a plane including the central axis has a tapered mountain shape that becomes thinner as it moves away from the valve disk 171 in the axial direction. The biasing portion 174 includes a notch portion 175 formed at the protruding tip portion to penetrate the tip portion in the radial direction of the biasing portion 174. The biasing portion 174 is provided with the plurality of notch portions 175 formed at intervals in the circumferential direction of the biasing portion 174. Thus, the protruding tip portion of the biasing portion 174 is intermittently notched in the circumferential direction of the biasing portion 174.

As described above, a radial gap exists between the valve member 133 and the plurality of disks 132. Then, the valve member 133 is press-fitted into the small diameter portion 161 of the cylindrical portion 153 of the case member 131 at the seal portion 173 thereof. By this press-fitting, the valve member 133 is centered to be coaxially disposed with respect to the case member 131, the plurality of disks 132, and the piston rod 21. At that time, the valve member 133 includes the seal portion 173 which comes into contact with the small diameter portion 161 over the entire circumference with a radial interference.

The seal portion 173 includes a cylindrical base portion 176 and an annular protrusion 177. The seal portion 173 is bonded to the valve disk 171 at the base portion 176 and is connected to the biasing portion 174. The protrusion 177 protrudes outward in the radial direction of the base portion 176 from a middle position in the axial direction of the base portion 176. When the elastic seal member 172 including the protrusion 177 is in a natural state without deformation as a whole, the outer diameter of the base portion 176 is smaller than the inner diameter of the small diameter portion 161. Further, when the elastic seal member 172 is in a natural state as a whole in this way, the outer diameter of the protrusion 177 is larger than the inner diameter of the small diameter portion 161 and smaller than the inner diameter of the large diameter portion 163.

The valve member 133 is press-fitted into the small diameter portion 161 of the cylindrical portion 153 of the case member 131 at the seal portion 173 thereof. Then, the protrusion 177 of the seal portion 173 is mainly elastically deformed inward in the radial direction and comes into close contact with the small diameter portion 161 over the entire circumference. Accordingly, the seal portion 173 is fitted liquid-tightly to the small diameter portion 161 of the cylindrical portion 153 of the case member 131 over the entire circumference.

The seal portion 173 is slidable on the cylindrical portion 153 in in the axial direction of the cylindrical portion 153. At that time, the seal portion 173 slides on the small diameter portion 161 in the axial direction of the cylindrical portion 153 while the protrusion 177 is in close contact with the small diameter portion 161 over the entire circumference. Accordingly, in the elastic seal member 172, the protrusion 177 of the seal portion 173 constantly seals a gap between the valve member 133 and the cylindrical portion 153. The cylindrical portion 153 is provided with the small diameter portion 161 formed in the sliding range of the protrusion 177 of the valve member 133. Then, the first inclined portion 162, the large diameter portion 163, the second inclined portion 164, and the opening end portion 165 which serve as guide sections of the valve member 133 are provided outside the small diameter portion 161 which is the sliding range of the protrusion 177 in the cylindrical portion 153. Among these, all the large diameter portion 163, the second inclined portion 164, and the opening end portion 165 are formed such that the inner diameters are larger than the outer diameter of the protrusion 177 of the valve member 133 in a natural state. The seal portion 173 is located on the radially outer side of the seat portion 154 of the case member 131. The valve disk 171 of the valve member 133 is seated on the seat portion 154.

The flexible member 135 has an outer diameter larger than the inner diameter of the valve member 133, that is, the inner diameter of the valve disk 171. The flexible member 135 is disposed on the opposite side to the bottom portion 150 in the axial direction of the valve disk 171 and is in pressure contact with a first support portion 178 on the inner peripheral side of the valve disk 171 over the entire circumference. Accordingly, the gap between the flexible member 135 and the valve disk 171, that is, the valve member 133 is closed.

As described above, the valve member 133 is centered relative to the valve case 145 by the seal portion 173 coming into contact with the cylindrical portion 153 over the entire circumference.

In this state, the first support portion 178 on the inner peripheral side of the valve disk 171 of the valve member 133 is disposed between the protrusion portion 151 and the flexible member 135 in the axial direction thereof. Then, the first support portion 178 is supported by the flexible member 135 such that one side surface on the opposite side to the bottom portion 150 in the axial direction thereof comes into contact with the flexible member 135. In other words, the valve member 133 includes the first support portion 178 of which one side surface on the radially inner side is supported by the flexible member 135. The first support portion 178 is supported by the flexible member 135 only on one side without being clamped on both sides. The first support portion 178 on the inner peripheral side of the valve disk 171 of the valve member 133 is movable in the range of the entire axial length of the plurality of (specifically, three) disks 132 between the protrusion portion 151 and the flexible member 135.

The valve member 133 is supported by the seat portion 154 such that a second support portion 179 disposed on the radially outer side of the first support portion 178 of the valve disk 171 comes into contact with the seat portion 154 at one side surface which is closer to the bottom portion 150 in the axial direction thereof. In other words, the valve member 133 includes the second support portion 179 that is disposed on the radially outer side of the first support portion 178 and has one side surface supported by the seat portion 154. The second support portion 179 is supported by the seat portion 154 on only one side without being clamped from both sides.

Thus, the valve member 133 has a simple support structure in which one side surface of the first support portion 178 of the valve disk 171 is supported by the flexible member 135 and the other side surface of the second support portion 179 on the radially outer side of the first support portion 178 of the valve disk 171 is supported by the seat portion 154. In other words, the valve disk 171 is not clamped in the axial direction.

In the valve member 133, the biasing portion 174 is disposed on the opposite side to the bottom portion 150 in the axial direction of the valve member 133. A part of the biasing portion 174 is disposed on the outside of the second support portion 179 in the radial direction of the valve member 133. The biasing portion 174 comes into contact with the support member 143 including the plurality of disks 140 at a portion disposed on the radially outer side of the second support portion 179. The biasing portion 174 biases the side of the second support portion 179 in the radial direction of the valve member 133 toward the seat portion 154 in the axial direction of the valve member 133. The entire biasing portion 174 may be disposed on the radially outer side of the second support portion 179. That is, at least a part of the biasing portion 174 in the valve member 133 may be disposed on the radially outer side of the second support portion 179.

The valve member 133 has a circular plate shape as a whole and is elastically deformable, that is, flexible as a whole. The valve member 133 is flexible so that the second support portion 179 moves away from the seat portion 154 while the first support portion 178 remains in contact with the flexible member 135. When bending in this manner, the valve member 133 is bent in the axial direction of the case member 131 to move the second support portion 179 toward the opposite side from the bottom portion 150 relative to the first support portion 178.

The outer diameter of the flexible member 135 becomes larger than the outer diameter of the disk 136 that comes into contact with the side surface on the opposite side to the first support portion 178 in the axial direction thereof. Thus, the flexible member 135 is flexible in the axial direction of the case member 131 in a direction away from the bottom portion 150.

The valve member 133 is flexible so that the second support portion 179 moves away from the seat portion 154 while the first support portion 178 remains in contact with the flexible member 135.

The flexible member 135 is flexible together with the valve member 133. The flexible member 135 is easily flexible such that the thickness is thinner than the thickness of the valve disk 171 of the valve member 133 and the rigidity is lower than the rigidity of the valve disk 171. The flexible member 135 is bent in the direction opposite to the bottom portion 150 due to the movement and deformation of the valve member 133 in the axial direction opposite to the seat portion 154. The stopper 142 including the stopper disks 137 to 139 suppresses the bending amount of the flexible member 135 in such a manner that the stopper disk 137 comes into contact with the flexible member 135 bent in this way. Here, the valve member 133 is flexible so that the second support portion 179 is moved further toward the opposite side of the bottom portion 150 than the first support portion 178 in the axial direction of the case member 131 even when the bending of the flexible member 135 is suppressed by the stopper 142.

The outer diameters of the plurality of disks 140 are larger than the outer diameter of the stopper disk 139 and smaller than the inner diameter of the cylindrical portion 153. In the support member 143 including the plurality of disks 140, the inner peripheral side comes into contact with the stopper disk 139 and the annular member 141 and the outer peripheral side comes into contact with the biasing portion 174 of the valve member 133. The support member 143 suppresses the valve member 133 from moving in the axial direction in a direction opposite to the bottom portion 150.

The seat portion 154 of the case member 131 supports the second support portion 179 of the valve disk 171 of the valve member 133 from one side in the axial direction. The flexible member 135 supports the first support portion 178 on the inner peripheral side of the seat portion 154 of the valve disk 171 from the other side in the axial direction. The shortest axial distance between the seat portion 154 and the flexible member 135 is slightly smaller than the axial thickness of the valve disk 171. Thus, the valve disk 171 is in pressure contact with both the seat portion 154 and the flexible member 135 due to its elastic force in a slightly elastically deformed state.

The valve member 133 is provided inside the case member 131 and divides the inside of the case member 131 into a first chamber 181 and a second chamber 182. The first chamber 181 is located between the bottom portion 150 and the valve member 133 in the axial direction of the case member 131. In other words, the first chamber 181 is located closer to the bottom portion 150 than the valve member 133 in the axial direction of the case member 131. The second chamber 182 is located between the valve member 133 and the support member 143 in the axial direction of the case member 131. The support member 143 is provided in the second chamber 182 to form the second chamber 182. The second chamber 182 is located on the opposite side to the bottom portion 150 in relation to the valve member 133 in the axial direction of the case member 131, that is, the opening side of the case member 131.

Both the first chamber 181 and the second chamber 182 have variable volumes and the volumes change according to the movement and deformation of the valve member 133. The first chamber 181 constantly communicates with the passage inside the groove portion 30 of the piston rod 21 through the passage inside the passage groove 158 of the case member 131. The first chamber 181 constantly communicates with the cylinder chamber 19 through the passage inside the passage groove 158, the passage inside the groove portion 30, the passage inside the notch 81 shown in FIG. 2, and the passages inside the passage groove 38 of the first passage 43 and the plurality of passage holes 37. Further, the first chamber 181 constantly communicates with the back pressure chamber 100 through the passage inside the passage groove 158 shown in FIG. 4, the passage inside the groove portion 30, and the passage inside the passage groove 79 shown in FIG. 3. The second chamber 182 constantly communicates with the cylinder chamber 20 through a passage portion 185 located between the support member 143 and the cylindrical portion 153 of the case member 131.

In the extension stroke, the oil L from the cylinder chamber 19 shown in FIG. 2 is introduced into the first chamber 181 through the passages inside the plurality of passage holes 37 and the passage groove 38 of the first passage 43, the passage inside the notch 81 of the disk 50, the passage inside the groove portion 30 of the piston rod 21, and the passage inside the passage groove 158 of the case member 131 shown in FIG. 4. Then, the valve disk 171 of the valve member 133 bends the flexible member 135 that contacts at the first support portion 178 in a direction away from the bottom portion 150 in the axial direction of the case member 131, that is, a direction of the stopper disk 137. At the same time, the valve disk 171 compresses and deforms the biasing portion 174 that is in contact with the support member 143 in the axial direction of the case member 131 between the support member 143 and the biasing portion 174. At the same time, the valve disk 171 is bent in a tapered shape with the contact point with the flexible member 135 as a fulcrum so that the second support portion 179 is farther away from the bottom portion 150 in the axial direction of the case member 131 than the first support portion 178. In this way, the valve disk 171 is bent to separate the second support portion 179 in relation to the first support portion 178 from the bottom portion 150 in the axial direction of the case member 131 with the contact point with the flexible member 135 as a fulcrum while moving away from the bottom portion 150 in the axial direction of the case member 131.

As the oil L is further introduced into the first chamber 181, the flexible member 135 that comes into contact with the valve disk 171 comes into contact with the stopper disk 137 of the stopper 142, and the bending is restricted. Then, the valve disk 171 is bent in a tapered shape with the contact point with the flexible member 135 as a fulcrum so that the second support portion 179 in relation to the first support portion 178 is further separated from the bottom portion 150 in the axial direction of the case member 131 while further compressing and deforming the biasing portion 174 between the support member 143 and the valve disk in the axial direction of the case member 131.

Due to the above-described movement and deformation of the valve disk 171, the valve member 133 increases the volume of the first chamber 181. Here, the volume of the second chamber 182 decreases when the valve disk 171 is deformed. At that time, the oil L of the second chamber 182 flows to the cylinder chamber 20 through the passage portion 185.

As shown in FIG. 2, the passages inside the plurality of passage holes 37 and the passage groove 38 of the first passage 43, the passage inside the notch 81, the passage inside the groove portion 30 of the piston rod 21, the passage inside the passage groove 158, the first chamber 181, the second chamber 182, and the passage portion 185 constitute a third passage 191. The third passage 191 constantly communicates with the cylinder chamber 19 through the passages inside the plurality of passage holes 37 of the first passage 43 and the passage groove 38, the passage inside the notch 81, the passage inside the groove portion 30, the passage inside the passage groove 158, and the first chamber 181. In the third passage 191, the passage portion 185 and the second chamber 182 constantly communicate with the cylinder chamber 20. The third passage 191 is a passage through which the oil L moves from the cylinder chamber 19 on the upstream side toward the cylinder chamber 20 on the downstream side during the extension stroke. The third passage 191 is a passage through which the oil L moves from the cylinder chamber 20 on the upstream side toward the cylinder chamber 19 on the downstream side during the compression stroke. In the frequency sensitive mechanism 130, the valve member 133 is provided in the third passage 191.

In the third passage 191, the passages inside the passage hole 37 and the passage groove 38 of the piston 18 are common to the first passage 43. In the third passage 191, the passage inside the notch 81 of the disk 50, the passage inside the groove portion 30 of the piston rod 21, the passage inside the passage groove 158, the first chamber 181, the second chamber 182, and the passage portion 185 are provided in parallel to the passage between the damping valve 91 and the valve seat portion 48 in the first passage 43 and the cylinder chamber 19 and the cylinder chamber 20 can communicate with each other.

In the valve member 133, the first support portion 178 shown in FIG. 4 on the inner peripheral side of the valve disk 171 is movable toward the bottom portion 150 in the axial direction between the case member 131 and the flexible member 135. Further, the valve member 133 is movable in the axial direction toward the opposite side to the bottom portion 150 until the bending of the flexible member 135 is suppressed by the stopper 142 while the first support portion 178 of the valve disk 171 bends the flexible member 135. When the first support portion 178 of the valve disk 171 is in contact with the flexible member 135 over the entire circumference, the valve member 133 blocks the flow of the oil L between the first chamber 181 and the second chamber 182. Further, the valve member 133 allows the flow of the oil L between the second chamber 182 and the first chamber 181 while the first support portion 178 of the valve disk 171 is separated from the flexible member 135 in the axial direction. The first support portion 178 of the valve disk 171 and the flexible member 135 constitute a check valve 193. The check valve 193 is provided in the third passage 191.

The check valve 193 restricts the flow of the oil L from the first chamber 181 toward the second chamber 182 through the third passage 191 and allows the flow of the oil L from the second chamber 182 toward the first chamber 181 through the third passage 191. The check valve 193 blocks communication between the cylinder chamber 19 and the cylinder chamber 20 through the third passage 191 during the extension stroke in which the pressure of the cylinder chamber 19 becomes higher than the pressure of the cylinder chamber 20. The check valve 193 allows the cylinder chamber 20 and the cylinder chamber 19 to communicate with each other through the third passage 191 during the compression stroke in which the pressure of the cylinder chamber 20 becomes higher than the pressure of the cylinder chamber 19. In this way, the third passage 191 allows the cylinder chamber 20 and the cylinder chamber 19 to communicate with each other when the check valve 193 is opened.

As shown in FIG. 2, the annular member 115, the disk 114, the disk 113, the plurality of disks 112, the disk 111, and the piston 18 are stacked on the shaft step portion 29 in that order while the mounting shaft portion 28 is inserted through the piston rod 21.

Further, as shown in FIG. 3, the disk 50, the disk 51, the valve disk 52, the plurality of valve disks 53, the pilot valve 60, the disk 61, the pilot case 62, the disk 63, the plurality of disks 64, the disk 65, and the disk 66 are stacked on the piston 18 in that order while the mounting shaft portion 28 is inserted therethrough from this state. At this time, the pilot case 62 includes the seal member 86 of the pilot valve 60 fitted into the outer cylindrical portion 73.

Further, as shown in FIG. 4, the case member 131 and the plurality of disks 132 are stacked on the disk 66 in that order while the mounting shaft portion 28 and the plurality of disks 132 are inserted therethrough from this state.

Further, the valve member 133 is stacked on the seat portion 154 of the case member 131 while the mounting shaft portion 28 and the plurality of disks 132 are inserted therethrough from this state. At this time, the elastic seal member 172 of the valve member 133 is fitted to the cylindrical portion 153 of the case member 131.

Further, the flexible member 135, the disk 136, the stopper disk 137, the plurality of stopper disks 138, the plurality of stopper disks 139, the plurality of disks 140, and the annular member 141 are stacked on the disk 132 and the valve disk 171 of the valve member 133 in that order while the mounting shaft portion 28 is inserted through each of them.

As shown in FIG. 2, a nut 195 is screwed onto the threaded portion 31 of the mounting shaft portion 28 that protrudes beyond the annular member 141 while components from the annular member 115 to the annular member 141 are arranged on the piston rod 21 as described above. Accordingly, the components from the annular member 115 to the annular member 141 are sandwiched by the shaft step portion 29 of the piston rod 21 and the nut 195 on the inner peripheral side or the entire part thereof and are clamped in the axial direction. At that time, the valve member 133 including the inner peripheral side is not clamped in the axial direction. In this state, as shown in FIG. 4, in the valve member 133, the first support portion 178 of the valve disk 171 comes into contact with the flexible member 135, the second support portion 179 comes into contact with the seat portion 154 of the case member 131, and the biasing portion 174 of the elastic seal member 172 comes into contact with the support member 143.

As described above, the components from the annular member 115 to the annular member 141 on the inner peripheral side or the entire part thereof are sandwiched by the shaft step portion 29 of the piston rod 21 and the nut 195 and are clamped in the axial direction. In this state, as shown in FIG. 3, in the pilot valve 60, a portion on the radially inner side of the pilot disk 85 corresponding to a portion on the radially inner side of the pilot valve is sandwiched by the inner seat 46 of the piston 18 and the disk 61 from both sides in the axial direction together with the disks 50 and 51 and the valve disks 52 and 53 and is fixed to the piston rod 21. Specifically, in the pilot disk 85, a portion overlapping both the inner seat 46 of the piston 18 and the disk 61 in the radial direction of the pilot valve 60 is fixed to the piston rod 21, the inner seat 46, and the disk 61.

Further, in this state, in the disks 50 and 51 and the valve disks 52 and 53, a portion on the radially inner side is sandwiched by the inner seat 46 of the piston 18 and the disk 61 from both sides in the axial direction together with the pilot disk 85 of the pilot valve 60 and is fixed to the piston rod 21. Specifically, in the disks 50 and 51 and the valve disks 52 and 53, a portion overlapping both the inner seat 46 of the piston 18 and the disk 61 in the radial direction is fixed to the piston rod 21, the inner seat 46, and the disk 61.

In this state, in all valve disks 53, a portion on the radially inner side and fixed to the piston rod 21, the inner seat 46, and the disk 61 serves as a fixed portion 201. In the plurality of valve disks 53, the fixed portion 201 on the radially inner side is fixed from both ends in the axial direction together with the pilot disk 85 of the pilot valve 60.

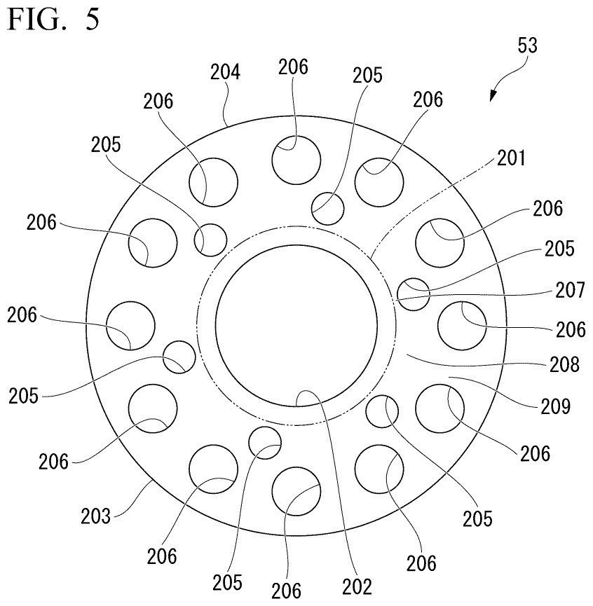

All the valve disks 53 have the same shape when viewed from the axial direction, and all of them have the shape shown in FIG. 5.

The valve disk 53 includes an inner peripheral end surface 202 on the radially inner side and an outer peripheral end surface 203 (radially outer end surface) on the radially outer side. The inner peripheral end surface 202 is a cylindrical surface having a constant diameter over the entire circumference. The outer peripheral end surface 203 is a cylindrical surface having a constant diameter over the entire circumference. In other words, the outer peripheral end surface 203 on the radially outer side of the valve disk 53 is formed by an annular, specifically, annular plate-shaped member. The inner peripheral end surface 202 on the radially inner side of the valve disk 53 is formed by an annular, specifically, annular plate-shaped member. In the valve disk 53, a predetermined range on the side of the inner peripheral end surface 202 in the radial direction including the inner peripheral end surface 202 serves as the fixed portion 201. The fixed portion 201 has an endless annular shape. In the valve disk 53, a predetermined range on the side of the outer peripheral end surface 203 in the radial direction including the outer peripheral end surface 203 serves as an outer peripheral edge portion 204. The outer peripheral edge portion 204 has an endless annular shape. In other words, the outer peripheral edge portion 204 is also formed by an annular plate-shaped member.

The valve disk 53 includes a plurality of, specifically, six first holes 205 (flexible promotion portions) and a plurality of, specifically, twelve second holes 206 (flexible promotion portions). All first holes 205 and all second holes 206 penetrate the valve disk 53 in the axial direction, that is, the thickness direction. All first holes 205 are circular holes having the same diameter. All second holes 206 are circular holes having the same diameter. The inner diameter of the second hole 206 is larger than the inner diameter of the first hole 205. In other words, the second hole 206 is formed to have a larger diameter than the first hole 205.

All first holes 205 are arranged at equal intervals in the circumferential direction of the inner peripheral end surface 202, that is, the circumferential direction of the valve disk 53. The centers of all first holes 205 are arranged at positions of equal distances from the center of the inner peripheral end surface 202, that is, the center of the valve disk 53.

All second holes 206 are arranged at equal intervals in the circumferential direction of the outer peripheral end surface 203, that is, the circumferential direction of the valve disk 53. All centers of all second holes 206 are arranged at positions of equal distances from the center of the inner peripheral end surface 202, that is, the center of the valve disk 53. The distance between the center of the second hole 206 and the center of the valve disk 53 is longer than the distance between the center of the first hole 205 and the center of the valve disk 53. In other words, the second hole 206 is disposed on the outside of the first hole 205 in the radial direction of the valve disk 53.

The first hole 205 is disposed at the central position between the second hole 206 and the second hole 206 adjacent to each other in the circumferential direction of the valve disk 53. The valve disk 53 has twelve central positions between the adjacent second holes 206 in the circumferential direction, the same number as the second holes 206. In contrast, the number of first holes 205 is half, i.e., six. Thus, the first holes 205 are arranged at alternate central positions in the circumferential direction of the valve disk 53 among the central positions between the second hole 206 and the second hole 206 adjacent to each other in the circumferential direction of the valve disk 53.

All first holes 205 and all second holes 206 are arranged in the range outside the fixed portion 201 in the radial direction of the valve disk 53, specifically, the range between the fixed portion 201 and the outer peripheral edge portion 204 in the radial direction thereof. In other words, the plurality of first holes 205 and the plurality of second hole 206 are formed in the valve disk 53 at a portion on the radially outer side of the fixed portion 201 and a portion on the radially inner side of the outer peripheral edge portion 204.

The valve disk 53 has an annular region in the vicinity of the fixed portion 201 in which neither the first hole 205 nor the second hole 206 is formed. This region serves as an inner region portion 207. The inner region portion 207 is located on the outside of the fixed portion 201 in the radial direction of the valve disk 53. Further, in the valve disk 53, an annular region in which the plurality of first holes 205 are formed serves as an intermediate region portion 208. The intermediate region portion 208 is located on the outside of the inner region portion 207 in the radial direction of the valve disk 53. Further, in the valve disk 53, an annular region in which the plurality of second holes 206 are formed serves as an outer region portion 209. The outer region portion 209 is located on the outside of the intermediate region portion 208 and the inside of the outer peripheral edge portion 204 in the radial direction of the valve disk 53.

In the valve disk 53, the axial rigidity of the intermediate region portion 208 provided with the plurality of first holes 205 is lower than that of the inner region portion 207 not provided with both the first hole 205 and the second hole 206. Further, in the valve disk 53, the axial rigidity of the outer region portion 209 in which the second holes 206 are formed and have a larger diameter and are more numerous than the first holes 205 has a lower axial rigidity than that of the intermediate region portion 208 provided with the plurality of first holes 205. The valve disk 53 includes the plurality of first holes 205 provided on the radially inner side, which promotes the axial bending in the intermediate region portion 208 on the radially outer side more than in the inner region portion 207 on the radially inner side. The valve disk 53 includes the plurality of second holes 206 provided on the radially outer side of the first hole 205, which promotes the axial bending in the outer region portion 209 on the radially outer side more than the intermediate region portion 208 on the radially inner side. In the valve disk 53, the first hole 205 and the second hole 206 are provided in a portion on the radially outer side of the fixed portion 201 and a portion on the radially inner side of the outer peripheral edge portion 204.

As shown in FIG. 1, the base valve 25 is provided between the bottom portion 12 of the outer cylinder 4 and the inner cylinder 3. The base valve 25 includes a base valve member 221, a disk valve 222, a disk valve 223, and a mounting pin 224. In the base valve 25, the base valve member 221 is placed on the bottom portion 12 and the base valve member 221 is fitted to the inner cylinder 3. The base valve member 221 divides the cylinder chamber 20 and the reservoir chamber 6. The disk valve 222 is provided on the lower side of the base valve member 221, that is, the side of the reservoir chamber 6. The disk valve 223 is provided on the upper side of the base valve member 221, that is, the side of the cylinder chamber 20. The mounting pin 224 attaches the disk valve 222 and the disk valve 223 to the base valve member 221.

The base valve member 221 includes an annular shape and the mounting pin 224 is inserted through the center of the base valve member in the radial direction. The base valve member 221 is provided with a plurality of passage holes 225 and a plurality of passage holes 226. The plurality of passage holes 225 allow the oil L to flow between the cylinder chamber 20 and the reservoir chamber 6. The plurality of passage holes 226 are arranged on the outside of the plurality of passage holes 225 in the radial direction of the base valve member 221. The plurality of passage holes 226 allow the oil L to flow between the cylinder chamber 20 and the reservoir chamber 6. The disk valve 222 on the side of the reservoir chamber 6 allows the flow of the oil L from the cylinder chamber 20 toward the reservoir chamber 6 through the passage hole 225. On the other hand, the disk valve 222 suppresses the flow of the oil L from the reservoir chamber 6 toward the cylinder chamber 20 through the passage hole 225. The disk valve 223 allows the flow of the oil L from the reservoir chamber 6 toward the cylinder chamber 20 through the passage hole 226. On the other hand, the disk valve 223 suppresses the flow of the oil L from the cylinder chamber 20 toward the reservoir chamber 6 through the passage hole 226.

The disk valve 222 and the base valve member 221 constitute a damping valve mechanism 227. The damping valve mechanism 227 is opened during the compression stroke of the shock absorber 1 so that the oil L flows from the cylinder chamber 20 toward the reservoir chamber 6 and a damping force is generated. The disk valve 223 and the base valve member 221 constitute a suction valve mechanism 228. The suction valve mechanism 228 is opened in the extension stroke of the shock absorber 1 so that the oil L flows from the reservoir chamber 6 into the cylinder chamber 20. Furthermore, the suction valve mechanism 228 functions to allow the oil L to flow from the reservoir chamber 6 to the cylinder chamber 20 without generating any substantial damping force to compensate for any shortage of oil caused by the extension of the piston rod 21 from the cylinder 2.

Next, the main operation of the shock absorber 1 will be described.

“Case of assuming that the frequency sensitive mechanism 130 is not operated and only the first damping force generating mechanism 41 and the second damping force generating mechanism 110 on the extension side are operated during the extension stroke”

In this case, when the moving speed of the piston 18 (hereinafter, referred to as piston speed) is lower than the first predetermined value, the oil L from the cylinder chamber 19 flows to the cylinder chamber 20 through the fixed orifice 92 of the first damping force generating mechanism 41 provided in the first passage 43 shown in FIG. 2. Thus, a damping force with orifice characteristics (the damping force is substantially proportional to the piston speed) is generated. Therefore, when the piston speed is lower than the first predetermined value, the damping force characteristic with respect to the piston speed is such that an increase rate of the damping force with respect to an increase in the piston speed is relatively high.

When the piston speed becomes equal to or higher than the first predetermined value and lower than a second predetermined value, the oil L from the cylinder chamber 19 passes between the disk valve 99 and the valve seat portion 75 while opening the disk valve 99 of the second damping force generating mechanism 110 and flows to the cylinder chamber 20 through the passages inside the plurality of passage holes 37 and the passage groove 38 of the first passage 43, the passage inside the notch 81, the passage inside the groove portion 30, the passage inside the passage groove 79, and the back pressure chamber 100. Thus, a damping force with valve characteristics (the damping force is substantially proportional to the piston speed) will be generated. Therefore, the characteristic of the damping force with respect to the piston speed when the piston speed is equal to or higher than the first predetermined value and lower than the second predetermined value is such that an increase rate of the damping force with respect to an increase in the piston speed becomes lower than when the piston speed is lower than the first predetermined value.

When the piston speed becomes equal to or higher than the second predetermined value, the relationship of the force (hydraulic pressure) acting on the damping valve 91 of the first damping force generating mechanism 41 is such that the force in the opening direction applied from the passages in the plurality of passage holes 37 and the passage groove 38 of the first passage 43 becomes larger than the force in the closing direction applied from the back pressure chamber 100. Thus, in this region, the damping valve 91 moves away from the valve seat portion 48 of the piston 18 to be opened as the piston speed increases. Thus, the oil L from the cylinder chamber 19 passes between the damping valve 91 and the valve seat portion 48 from the first passage 43 and flows to the cylinder chamber 20 while opening the damping valve 91 in addition to the flow passing between the disk valve 99 and the valve seat portion 75 while opening the disk valve 99 and flowing to the cylinder chamber 20. Therefore, an increase rate of the damping force with respect to an increase in the piston speed when the piston speed is equal to or higher than the second predetermined value is lower than when the piston speed is equal to or higher than the first predetermined value and lower than the second predetermined value.

“Case of assuming that the frequency sensitive mechanism 130 is not operated and only the first damping force generating mechanism 42 on the compression side is operated during the compression stroke”

In this case, when the piston speed is lower than a third predetermined value, the oil L from the cylinder chamber 20 flows to the cylinder chamber 19 through the first passage 44 and the fixed orifice 123 of the first damping force generating mechanism 42. Accordingly, a damping force with orifice characteristics will be generated. Therefore, the characteristic of the damping force with respect to the piston speed when the piston speed is lower than the third predetermined value is such that an increase rate of the damping force with respect to an increase in the piston speed is relatively high.

When the piston speed becomes equal to or higher than the third predetermined value, the oil L introduced from the cylinder chamber 20 into the first passage 44 passes between the disk valve 122 and the valve seat portion 49 while opening the disk valve 122 of the first damping force generating mechanism 42 and flows to the cylinder chamber 19. Accordingly, a damping force with valve characteristics will be generated. Therefore, the characteristic of the damping force with respect to the piston speed when the piston speed is equal to or higher than the third predetermined value is such that an increase rate of the damping force with respect to an increase in the piston speed is lower than when the piston speed is lower than the third predetermined value.

“Case of operating the frequency sensitive mechanism 130 during the extension stroke”

In the first embodiment, the frequency sensitive mechanism 130 varies the damping force according to the piston frequency even when the piston speed is the same.

In the extension stroke, the oil L is introduced from the cylinder chamber 19 into the first chamber 181 of the frequency sensitive mechanism 130 through the passages inside the plurality of passage holes 37 and the passage groove 38 of the first passage 43, the passage inside the notch 81, the passage inside the groove portion 30, and the passage inside the passage groove 158. Then, in the valve member 133 that comes into contact with the flexible member 135, the seat portion 154, and the support member 143, the valve disk 171 bends the flexible member 135 that comes into contact with the first support portion 178 in a direction away from the bottom portion 150 in the axial direction of the case member 131. At the same time, the valve disk 171 compresses and deforms the biasing portion 174 that comes into contact with the support member 143 between the support member 143 and the valve disk in the axial direction of the case member 131. At the same time, the valve disk 171 is bent in a tapered shape with the contact point with the flexible member 135 as a fulcrum to separate the second support portion 179 in relation to the first support portion 178 from the bottom portion 150 in the axial direction of the case member 131.

When the oil L is further introduced into the first chamber 181 and the flexible member 135 comes into contact with the stopper 142 to restrict the bending, the valve disk 171 is bent in a tapered shape with the contact point with the flexible member 135 as a fulcrum so that the second support portion 179 in relation to the first support portion 178 is further separated from the bottom portion 150 in the axial direction of the case member 131 while further compressing and deforming the biasing portion 174 between the support member 143 and the valve disk in the axial direction of the case member 131.

The valve member 133 expands the volume of the first chamber 181 in the above-described manner, and introduces the oil L into the first chamber 181. At that time, the valve member 133 discharges the oil L from the second chamber 182 to the cylinder chamber 20 through the passage portion 185.

Here, the stoke of the piston 18 is small during the extension stroke when the piston frequency is high. Therefore, the amount of the oil L introduced from the cylinder chamber 19 into the first chamber 181 through the passages inside the plurality of passage holes 37 and the passage groove 38 of the first passage 43, the passage inside the notch 81, the passage inside the groove portion 30, and the passage inside the passage groove 158 is small. Thus, the valve member 133 is not deformed to near the above-described deformation limit.

Thus, in the extension stroke when the piston frequency is high, the oil L is introduced from the cylinder chamber 19 into the first chamber 181 in such a manner that the valve member 133 of the frequency sensitive mechanism 130 is moved and bent as described above while bending the flexible member 135 every extension stroke. Then, the flow rate of the oil L flowing from the cylinder chamber 19 to the cylinder chamber 20 through the passages inside the plurality of passage holes 37 and the passage groove 38 of the first passage 43, the passage inside the notch 81, the passage inside the groove portion 30, the passage inside the passage groove 79, and the back pressure chamber 100 while opening the disk valve 99 of the second damping force generating mechanism 110 decreases. In addition, the flow rate of the oil L flowing from the first passage 43 to the cylinder chamber 20 while opening the damping valve 91 of the first damping force generating mechanism 41 also decreases. Additionally, since the oil L is introduced from the cylinder chamber 19 to the first chamber 181, an increase in the pressure of the back pressure chamber 100 is suppressed compared to the case where the first chamber 181 is not provided and hence the damping valve 91 of the first damping force generating mechanism 41 is easily opened. As a result, the extension side damping force becomes soft.

On the other hand, the stoke of the piston 18 is large during the extension stroke when the piston frequency is low. Therefore, the amount of the oil L introduced from the cylinder chamber 19 into the first chamber 181 through the passages inside the plurality of passage holes 37 and the passage groove 38 of the first passage 43, the passage inside the notch 81, the passage inside the groove portion 30, and the passage inside the passage groove 158 is large. Thus, the oil L flows from the cylinder chamber 19 to the first chamber 181 at the beginning of the stroke of the piston 18, but thereafter, the flexible member 135 and the valve member 133 are deformed to near their limits and are not deformed any further. As a result, the oil L does not flow from the cylinder chamber 19 to the first chamber 181. Accordingly, the flow rate of the oil L flowing from the cylinder chamber 19 to the cylinder chamber 20 through the passages inside the plurality of passage holes 37 and the passage groove 38 of the first passage 43, the passage inside the notch 81, the passage inside the groove portion 30, the passage inside the passage groove 79, and the back pressure chamber 100 while opening the second damping force generating mechanism 110 does not decrease. In addition, the flow rate of the oil L flowing from the first passage 43 to the cylinder chamber 20 while opening the damping valve 91 of the first damping force generating mechanism 41 also does not decrease. Additionally, since the oil L is not introduced from the cylinder chamber 19 into the first chamber 181, the pressure of the back pressure chamber 100 increases and the damping valve 91 of the first damping force generating mechanism 41 is not easily opened. As a result, the damping force is harder than at higher frequencies during the extension stroke when the piston frequency is low.

Although the pressure of the cylinder chamber 20 increases during the compression stroke, the valve disk 171 of the valve member 133 of the frequency sensitive mechanism 130 comes into contact with the seat portion 154 of the case member 131 at the second support portion 179 to suppress the expansion of the second chamber 182. Therefore, the amount of the oil L introduced from the cylinder chamber 20 into the second chamber 182 through the passage portion 185 is suppressed. As a result, the flow rate of the oil L introduced from the cylinder chamber 20 into the first passage 44, passing through the first damping force generating mechanism 42, and flowing to the cylinder chamber 19 does not decrease. Thus, the damping force becomes hard. When the piston speed increases and the pressure of the second chamber 182 becomes higher than the pressure of the first chamber 181 by a predetermined value or more during the compression stroke, the first support portion 178 on the inner peripheral side of the valve member 133 moves away from the flexible member 135. In other words, the check valve 193 is opened. Accordingly, the oil L flows from the cylinder chamber 20 to the cylinder chamber 19 through the passage portion 185, the second chamber 182, the check valve 193, the first chamber 181, the passage inside the passage groove 158, the passage inside the groove portion 30, the passage inside the notch 81, and the passages inside the passage groove 38 and the plurality of passage holes 37 of the first passage 43. In this way, since the check valve 193 is opened, the valve member 133 suppresses the pressure difference between the second chamber 182 and the first chamber 181. Thus, the valve member 133 is suppressed from bending excessively.

The above-described Patent Document 1 describes a shock absorber having a pressure-controlled valve that applies a back pressure to the valve in the valve closing direction. In this type of shock absorber, the damping valve makes the damping force have soft characteristics when high-frequency vibration is input and the piston speed is fast and the damping valve makes the damping force have hard characteristics when low-frequency vibration is input and the piston speed is slow. In this case, when the damping valve has soft damping force characteristics, the closing pressure becomes low, and since the valve opening amount is determined by the stiffness (ease of bending), the stiffness of the damping valve is often set low. Further, when the damping valve has hard damping force characteristics, back pressure is applied to the valve to generate a high closing pressure, and the valve opening amount is restricted. In this case, the valve is deformed due to the difference pressure between opening and closing the valve and the stress near the fulcrum increases at that time, which can affect durability. When the rigidity of the valve is increased, durability is improved, but the lower limit value of the damping force in soft characteristics increases.

In the shock absorber 1 of the first embodiment, the first damping force generating mechanism 41 includes the pilot valve 60 of which the radially inner side is fixed from both sides in the axial direction and which is disposed to be able to close the first passage 43 and one or more valve disks 53 in which the fixed portion 201 on the radially inner side is fixed from both axial ends together with the pilot valve 60 to bias the first passage 43 in the valve closing direction. Then, the valve disk 53 is provided with the first hole 205 and the second hole 206 which are formed in a portion on the radially outer side of the fixed portion 201 to promote the axial bending on the radially outer side in relation to the radially inner side. The valve disk 53 has a structure in which the rigidity of the first hole 205 and the second hole 206 is gradually reduced from the radially inner side to the radially outer side while the rigidity of the inner region portion 207 in the vicinity of the fixed portion 201 is ensured. Thus, since the rigidity in the vicinity of the fixed portion 201 is ensured in the valve disk 53, the bending amount in the vicinity of the fixed portion 201 is reduced and the stress in the vicinity of the fixed portion 201 is reduced. Thus, the durability of the valve disk 53 can be improved. Further, the rigidity of the valve disk 53 is gradually reduced from the radially inner portion to the radially outer portion by the first hole 205 and the second hole 206, so that the radially outer portion is easily bent. Therefore, the influence on the lower limit value of the damping force when the soft characteristic is set can be suppressed.

Further, in the shock absorber 1 of the first embodiment, the pilot valve 60 is formed to have a larger diameter than the valve disk 53 and the radially outer side of the valve seat portion 48 is bent to cover the valve disk 53 by the pressure applied from the second passage 102. Accordingly, in the valve disk 53, the pressure applied from the second passage 102 acts in the valve closing direction through the pilot valve 60. In this way, even in the valve disk 53 when the pressure of the second passage 102 is applied in the valve closing direction, it is possible to obtain improved durability and ease of bending.

Further, in the shock absorber 1 of the first embodiment, since the valve disk 53 includes the first hole 205 provided on the radially inner side and the second hole 206 provided on the radially outer side of the first hole 205, the axial bending is promoted on the radially outer side in relation to the radially inner side. Accordingly, a portion that promotes the axial bending on the radially outer side in relation to the radially inner side can be easily formed in the valve disk 53 by press molding or the like.

Further, in the shock absorber 1 of the first embodiment, since the second hole 206 is formed to have a larger diameter than the first hole 205, it is easier to promote the axial bending on the radially outer side than on the radially inner side.

Further, in the shock absorber 1 of the first embodiment, since the radially outer peripheral end surface 203 of the valve disk 53 is formed by an annular plate-shaped member, distortion and the like is less likely to occur during processing.

Further, in the shock absorber 1 of the first embodiment, the valve disk 53 is provided at the second axial end portion of the pilot valve 60 having the seal member 86 at the first axial end portion. Therefore, the opposite side to the valve disk 53 in the pilot valve 60 can be the back pressure chamber 100. Then, the pressure of the back pressure chamber 100 can be applied to the valve disk 53 through the pilot valve 60.

In the shock absorber 1 of the first embodiment, all valve disks 53 include the first hole 205 and the second hole 206 that promote the axial bending on the radially outer side in relation to the radially inner side, but any one valve disk 53 of all valve disks 53 may not include the first hole 205 and the second hole 206. That is, at least one of the valve disks 53 may include the first hole 205 and the second hole 206. In that case, the other valve disk 53 may have a shape that does not have a portion penetrating in the axial direction between the outer peripheral end surface 203 and the inner peripheral end surface 202. Further, in that case, the valve disk 53 disposed at any position in the stacking direction in all valve disks 53 may include the first hole 205 and the second hole 206.

### Second Embodiment

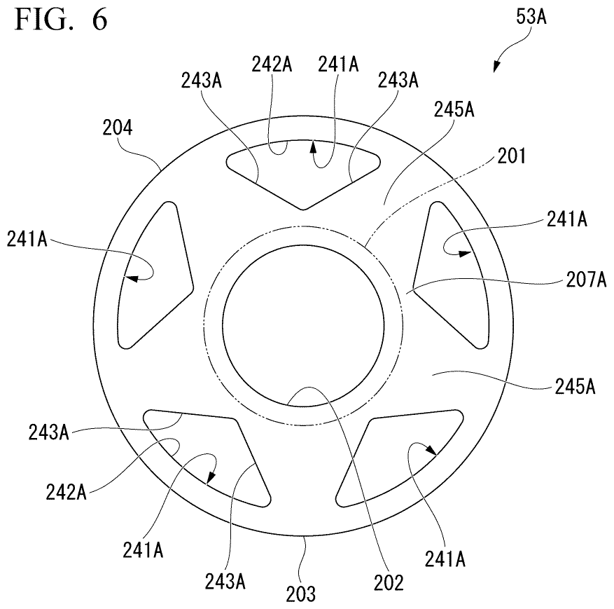

Next, a second embodiment will be described mainly with reference to FIG. 6 by focusing on the differences from the first embodiment. Furthermore, the same parts as those in the first embodiment are indicated by the same names and symbols.

In the second embodiment, a valve disk 53A shown in FIG. 6 and partially different from the valve disk 53 is provided in place of the valve disk 53. In the second embodiment, an equal number of valve disks 53A are provided instead of all valve disks 53.

The valve disk 53A includes the inner peripheral end surface 202 and the outer peripheral end surface 203 similarly to the valve disk 53. The valve disk 53A includes a plurality of, specifically, five irregular holes 241A (flexible promotion portions) instead of the first hole 205 and the second hole 206. All irregular holes 241A penetrate the valve disk 53A in the axial direction, that is, the thickness direction. These irregular holes 241A all have the same shape when the valve disk 53A is viewed in the axial direction.

All irregular holes 241A are arranged at equal intervals in the circumferential direction of the inner peripheral end surface 202 and the outer peripheral end surface 203, that is, the circumferential direction of the valve disk 53A. All irregular holes 241A are arranged at the positions away from the center of the inner peripheral end surface 202, that is, the center of the valve disk 53A, by the equal distance.

The irregular hole 241A includes an arc-shaped portion 242A and a pair of linear portions 243A. The arc-shaped portion 242A is coaxial with the outer peripheral end surface 203 and has an arc shape with a smaller diameter than the outer peripheral end surface 203. The pair of linear portions 243A have a linear shape and the same length. The pair of linear portions 243A extend from both end portions of the arc-shaped portion 242A toward the inner peripheral end surface 202 and join together. Thus, the irregular hole 241A has a sector shape. The irregular hole 241A is formed to increase the diameter outward in the radial direction of the valve disk 53A. The pair of linear portions 243A form an obtuse angle.

All irregular holes 241A are arranged in the range outside the fixed portion 201 in the radial direction of the valve disk 53A, in other words, the range between the fixed portion 201 and the outer peripheral edge portion 204 in the radial direction thereof. In other words, the valve disk 53A includes the plurality of irregular holes 241A formed in a part on the radially outer side of the fixed portion 201 and a part on the radially inner side of the outer peripheral edge portion 204.

The irregular holes 241A are arranged so that the length in the circumferential direction of the valve disk 53A increases outward in the radial direction of the valve disk 53A. In the valve disk 53A, an annular region not provided with the irregular hole 241A around the fixed portion 201 serves as an inner region portion 207A. The inner region portion 207A is located on the outside of the fixed portion 201 in the radial direction of the valve disk 53. In the valve disk 53A, an annular region provided with the plurality of irregular holes 241A serves as a rigidity change portion 245A. The rigidity of the rigidity change portion 245A decreases outward in the radial direction of the valve disk 53A. The rigidity change portion 245A is located on the outside of the inner region portion 207A and the inside of the outer peripheral edge portion 204 in the radial direction of the valve disk 53.

The valve disk 53A includes the plurality of irregular holes 241A that promote the axial bending on the radially outer side in relation to the radially inner side. The valve disk 53A includes the irregular hole 241A provided in a part on the radially outer side of the fixed portion 201 and a part on the radially inner side of the outer peripheral edge portion 204.

The valve disk 53A has a constant outer diameter over the entire circumference and a constant inner diameter over the entire circumference. All valve disks 53A have a constant radial width. The outer diameter of the valve disk 53A is equal to the outer diameter of the valve disk 53 and the inner diameter thereof is equal to the inner diameter of the valve disk 53.

The valve disk 53A is slightly elastically deformed while a plurality of identically shaped disks are stacked and is brought into contact with the valve disk 52 (see FIG. 3). Accordingly, each of the plurality of valve disks 53A generates a biasing force due to its elasticity in a direction of coming into contact with the valve seat portion 48 (see FIG. 3). As a result, the plurality of valve disks 53A apply a biasing force in a direction of coming into contact with the valve seat portion 48 (see FIG. 3) to the valve disk 52 (see FIG. 3) due to their elasticity. The valve disk 53A may not be a plurality of disks and may be a single disk.

In the second embodiment, the valve disk 53A includes the irregular hole 241A that promotes the axial bending of the rigidity change portion 245A on the radially outer side in relation to the inner region portion 207A on the radially inner side in a part on the radially outer side of the fixed portion 201. The irregular hole 241A promotes the axial bending on the radially outer side in relation to the radially inner side in the rigidity change portion 245A. The valve disk 53A has a structure in which the rigidity of the portion on the radially outer side of the inner region portion 207A is gradually reduced from the radially inner side to the radially outer side while the irregular hole 241A ensures the rigidity of the inner region portion 207A in the vicinity of the fixed portion 201. Thus, similarly to the valve disk 53, the durability of the valve disk 53A can be improved and the influence on the lower limit value of the damping force in the soft characteristics can be suppressed.

Further, since the valve disk 53A includes the irregular hole 241A that is formed to increase the diameter outward in the radial direction to promote the axial bending on the radially outer side in relation to the radially inner side, it is easier to promote the axial bending on the radially outer side in relation to the radially inner side.

Further, since the outer peripheral end surface 203 on the radially outer side of the valve disk 53A is formed by an annular plate-shaped member, distortion or the like is unlikely to occur during processing.

Here, any one valve disk 53A of all valve disks 53A may not include the irregular hole 241A. That is, at least one of the valve disks 53A may include the irregular hole 241A. In that case, the other valve disk 53A may have a shape that does not have a portion penetrating in the axial direction between the outer peripheral end surface 203 and the inner peripheral end surface 202. Further, in that case, any valve disk 53A disposed at any position in the stacking direction in all valve disks 53A may include the irregular hole 241A.

### Third Embodiment

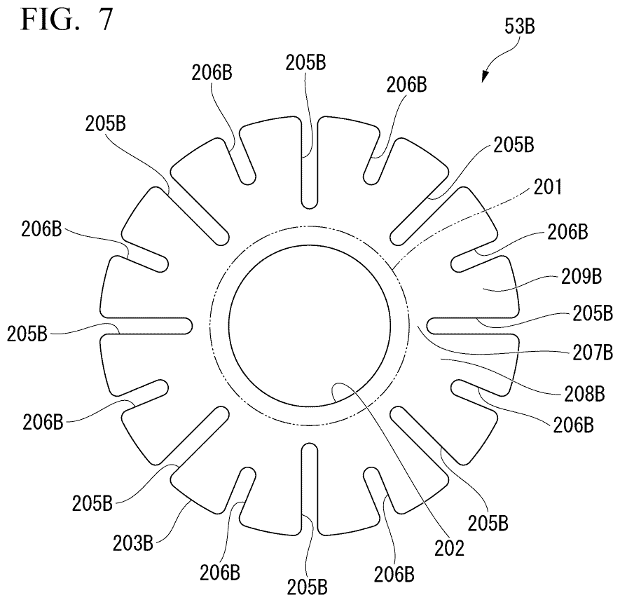

Next, a third embodiment will be described mainly with reference to FIG. 7 by focusing on the differences from the first embodiment. Furthermore, the same parts as those in the first embodiment are indicated by the same names and symbols.

In the third embodiment, a valve disk 53B shown in FIG. 7 and partially different from the valve disk 53 in the shock absorber 1 of the first embodiment is provided in place of the valve disk 53. In the third embodiment, an equal number of valve disks 53B are provided instead of all valve disks 53.

The valve disk 53B includes the inner peripheral end surface 202 similar to that of the valve disk 53 and an outer peripheral end surface 203B different from that of the valve disk 53.

The valve disk 53B includes a plurality of, specifically, eight first grooves 205B (flexible promotion portions) and a plurality of, specifically, eight second grooves 206B (flexible promotion portions) instead of the first hole 205 and the second hole 206. All first grooves 205B and all second grooves 206B penetrate the valve disk 53B in the axial direction, that is, the thickness direction. All first grooves 205B and all second grooves 206B extend in the radial direction of the valve disk 53B.

All first grooves 205B are linear grooves having the same shape that extend inward in the radial direction of the valve disk 53B from the outer peripheral end surface 203B. All second grooves 206B are linear grooves having the same shape that extend inward in the radial direction of the valve disk 53B from the outer peripheral end surface 203B. The outer peripheral end surface 203B has a cylindrical surface shape that is interrupted in the circumferential direction by forming the plurality of first grooves 205B and the plurality of second grooves 206B. The outer diameter of the portion excluding the first groove 205B and the second groove 206B of the outer peripheral end surface 203B is equal to the outer diameter of the outer peripheral end surface 203 of the valve disk 53. The length of the second groove 206B in the radial direction of the valve disk 53B becomes shorter than the length of the first groove 205B in the same direction. In other words, the first groove 205B extends inward in the radial direction of the valve disk 53B in relation to the second groove 206B.

All first grooves 205B are arranged at equal intervals in the circumferential direction of the inner peripheral end surface 202, that is, the circumferential direction of the valve disk 53B. The inner end portions of all first grooves 205B in the radial direction of the inner peripheral end surface 202, that is, the radial direction of the valve disk 53B, are arranged at positions of equal distances from the center of the inner peripheral end surface 202, that is, the center of the valve disk 53B.

All second grooves 206B are arranged at equal intervals in the circumferential direction of the valve disk 53. The inner end portions of all second grooves 206B in the radial direction of the valve disk 53B are arranged at positions of equal distances from the center of the valve disk 53B.

In the valve disk 53B, one second groove 206B is disposed at the central position between the first groove 205B and the first groove 205B adjacent to each other in the circumferential direction thereof. In other words, the first groove 205B and the second groove 206B are alternately arranged at equal intervals in the circumferential direction in the valve disk 53B.

All first grooves 205B and all second grooves 206B are arranged outside the fixed portion 201 in the radial direction of the valve disk 53B. In other words, the plurality of first grooves 205B and the plurality of second grooves 206B are formed in a part on the radially outer side of the fixed portion 201 in the valve disk 53B.

In the valve disk 53, an annular region not provided with both the first groove 205B and the second groove 206B in the vicinity of the fixed portion 201 serves as an inner region portion 207B. The inner region portion 207B is located on the outside of the fixed portion 201 in the radial direction of the valve disk 53B. Further, in the valve disk 53, an annular region provided with only the plurality of first grooves 205B serves as an intermediate region portion 208B. The intermediate region portion 208B is located on the outside of the inner region portion 207B in the radial direction of the valve disk 53B. Further, in the valve disk 53B, an annular region provided with both the plurality of first grooves 205B and the plurality of second grooves 206B serves as an outer region portion 209B. The outer region portion 209B is located on the outside of the intermediate region portion 208B in the radial direction of the valve disk 53.

In the valve disk 53B, the axial rigidity of the intermediate region portion 208B provided with the plurality of first grooves 205B is lower than that of the inner region portion 207B not provided with both the first groove 205B and the second groove 206B. Further, in the valve disk 53B, the axial rigidity of the outer region portion 209B provided with the plurality of second grooves 206B in addition to the plurality of first grooves 205B is lower than that of the intermediate region portion 208B provided with only the plurality of first grooves 205B. In the valve disk 53B, the plurality of first grooves 205B and the plurality of second grooves 206B promote the axial bending in the intermediate region portion 208B in relation to the inner region portion 207B on the radially inner side and promotes the axial bending in the outer region portion 209B on the radially outer side in relation to the intermediate region portion 208B on the radially inner side. In the valve disk 53B, the first groove 205B and the second groove 206B are provided in a part on the radially outer side of the fixed portion 201.

The valve disk 53B is slightly elastically deformed while a plurality of identically shaped disks are stacked and is brought into contact with the valve disk 52 (see FIG. 3). Accordingly, each of the plurality of valve disks 53B generates a biasing force due to its elasticity in a direction of coming into contact with the valve seat portion 48 (see FIG. 3). As a result, the plurality of valve disks 53B apply a biasing force in a direction of coming into contact with the valve seat portion 48 (see FIG. 3) to the valve disk 52 (see FIG. 3) due to their elasticity. The valve disk 53B may be a plurality of disks and may be a single disk.

In the third embodiment, the valve disk 53B includes the first groove 205B and the second groove 206B provided in a part on the radially outer side of the fixed portion 201 to promote the axial bending on the radially outer side in relation to the radially inner side. In the valve disk 53B, the first groove 205B reduces the rigidity of the intermediate region portion 208B on the radially outer side in relation to the inner region portion 207B on the radially inner side while ensuring the rigidity of the inner region portion 207B in the vicinity of the fixed portion 201. Further, in the valve disk 53B, the first groove 205B and the second groove 206B reduce the rigidity of the outer region portion 209B on the radially outer side in relation to the rigidity of the intermediate region portion 208B on the radially inner side. Thus, similarly to the valve disk 53, the durability of the valve disk 53B can be improved and the influence on the lower limit value of the damping force in the soft characteristics can be suppressed.

Further, since both the first groove 205B and the second groove 206B extend inward along the radial direction of the valve disk 53B from the outer peripheral end surface 203B of the valve disk 53B, it is easier to promote the axial bending on the radially outer side than on the radially inner side.

Here, any one valve disk 53B of all valve disks 53B may not include the first groove 205B and the second groove 206B. That is, at least one of the valve disks 53B may include the first groove 205B and the second groove 206B. In that case, the other valve disk 53B may have a shape that does not have a portion penetrating in the axial direction between the outer peripheral end surface 203B and the inner peripheral end surface 202. Further, in that case, the valve disk 53B disposed at any position in the stacking direction in all valve disks 53B may include the first groove 205B and the second groove 206B.

The valve disks 53, 53A, and 53B can also be appropriately and selectively combined. That is, the damping valve 91 can be used in combination with all the valve disks 53, 53A, and 53B. Further, the damping valve 91 can be used in combination with only the valve disks 53 and 53A among the valve disks 53, 53A, and 53B. Further, the damping valve 91 can be used in combination with only the valve disks 53 and 53B among the valve disks 53, 53A, and 53B. Further, the damping valve 91 can be used in combination with only the valve disks 53A and 53B among the valve disks 53, 53A, and 53B.

Furthermore, although the hydraulic shock absorber has been described as an example in the first to third embodiments, the above structure can also be adopted in a shock absorber that uses water or air as the working fluid.

### INDUSTRIAL APPLICABILITY

According to the above aspects of the present invention, the durability of the valve can be improved, and thus the industrial applicability is great.

### REFERENCE SIGNS LIST

1 Shock absorber
2 Cylinder
18 Piston
19 Cylinder chamber
20 Cylinder chamber
21 Piston rod
41 First damping force generating mechanism
43 First passage
48 Valve seat portion (seat portion)
53, 53A, 53B Valve disk (second valve)
60 Pilot valve (first valve)
86 Seal member
102 Second passage
110 Second damping force generating mechanism
201 Fixed portion
203 Outer peripheral end surface (radially outer end surface)
205 First hole (flexible promotion portion)
206 Second hole (flexible promotion portion)
241A Irregular hole (flexible promotion portion)
205B First groove (flexible promotion portion)
206B Second groove (flexible promotion portion)

1. A shock absorber comprising:
a cylinder in which a working fluid is sealed;
a piston which is slidably fitted into the cylinder and divides an inside of the cylinder into two cylinder chambers;
a piston rod of which a first end portion is connected to the piston and a second end portion is extended to an outside of the cylinder;
a first passage through which the working fluid flows from at least one cylinder chamber as the piston moves;
a first damping force generating mechanism which is provided in the first passage and generates a damping force;
a second passage which is provided in parallel to the first passage and through which the working fluid flows from at least one cylinder chamber in accordance with the movement of the piston to pressurize the first damping force generating mechanism in a valve closing direction; and
a second damping force generating mechanism which is provided in parallel to the second passage,
wherein the first damping force generating mechanism includes a first valve which is fixed from both axial sides on the radially inner side and is disposed to be able to close the first passage and one or more second valves of which a fixed portion on the radially inner side is fixed from both axial ends together with the first valve and which generate a force of biasing the first passage in a valve closing direction,
wherein the second valve is formed to have a larger diameter than the inner diameter of a seat portion provided on the outer peripheral side of the first passage and at least one second valve includes a flexible promotion portion provided in a part on the radially outer side of the fixed portion to promote axial bending on the radially outer side in relation to the radially inner side,
wherein the flexible promotion portion corresponds to a first hole provided on the radially inner side and a second hole provided on the radially outer side of the first hole, and
wherein the second hole is formed to have a larger diameter than the first hole.

2.-4. (canceled)

5. A shock absorber comprising:
a cylinder in which a working fluid is sealed;
a piston which is slidably fitted into the cylinder and divides an inside of the cylinder into two cylinder chambers;
a piston rod of which a first end portion is connected to the piston and a second end portion is extended to an outside of the cylinder;
a first passage through which the working fluid flows from at least one cylinder chamber as the piston moves;
a first damping force generating mechanism which is provided in the first passage and generates a damping force;
a second passage which is provided in parallel to the first passage and through which the working fluid flows from at least one cylinder chamber in accordance with the movement of the piston to pressurize the first damping force generating mechanism in a valve closing direction; and
a second damping force generating mechanism which is provided in parallel to the second passage,
wherein the first damping force generating mechanism includes a first valve which is fixed from both axial sides on the radially inner side and is disposed to be able to close the first passage and one or more second valves of which a fixed portion on the radially inner side is fixed from both axial ends together with the first valve and which generate a force of biasing the first passage in a valve closing direction,
wherein the second valve is formed to have a larger diameter than the inner diameter of a seat portion provided on the outer peripheral side of the first passage and at least one second valve includes a flexible promotion portion provided in a part on the radially outer side of the fixed portion to promote axial bending on the radially outer side in relation to the radially inner side, and
wherein the flexible promotion portion is formed to increase the diameter outward in the radial direction.

6. The shock absorber according to claim 1,
wherein the second valve has a radially outer end surface formed by an annular plate-shaped member.

7.-9. (canceled)

10. The shock absorber according to claim 1,
wherein the first valve includes a seal member at a first axial end portion, and
wherein the second valve is provided at a second axial end portion of the first valve.

11.-17. (canceled)

18. The shock absorber according to claim 1,
wherein the first valve is formed to have a larger diameter than the second valve and is bent by the pressure applied from the second passage so that the second valve is covered on the radially outer side of the seat portion.

19. The shock absorber according to claim 2,
wherein the second valve has a radially outer end surface formed by an annular plate-shaped member.

20. The shock absorber according to claim 2,
wherein the first valve includes a seal member at a first axial end portion, and
wherein the second valve is provided at a second axial end portion of the first valve.

21. The shock absorber according to claim 2,
wherein the first valve is formed to have a larger diameter than the second valve and is bent by the pressure applied from the second passage so that the second valve is covered on the radially outer side of the seat portion.
